(19) United States
(12) Patent Application Publication
(10) Pub. No.: US 2026/0275640 A1
(43) Pub. Date: Sep. 17, 2026

(54) UNIDIRECTIONAL WOOD FIBER PAPER AND PREPARATION METHOD THEREFOR, UNIDIRECTIONAL WOOD FIBER PAPER PREPREG AND PREPARATION METHOD THEREFOR, AND WOOD FIBER PAPER-REINFORCED COMPOSITE MATERIAL

(71) Applicant: FRESHAPE SA, Renens VD (SZ)

(72) Inventors: Yunlong JIA, Shanghai (CN); Zuoxin ZHOU, Shanghai (CN); Ruonan WANG, Shanghai (CN); Longjiang DUAN, Shanghai (CN); Haocheng WU, Shanghai (CN); Shihui LIN, Shanghai (CN); Yunlong ZHENG, Shanghai (CN)

(21) Appl. No.: 19/668,852

(22) Filed: May 6, 2026

Related U.S. Application Data
(63) Continuation of application No. PCT/CN2024/132395, filed on Nov. 15, 2024.

(30) Foreign Application Priority Data
Feb. 6, 2024 (CN) 202410171644.0

(51) Int. Cl. D21H 15/02; B31F 7/00; C08J 5/24; D21F 13/00

(52) U.S. Cl. CPC D21H 15/02; B31F 7/00; C08J 5/245; D21F 13/00

(57) ABSTRACT

A unidirectional wood fiber paper is provided. The unidirectional wood fiber paper is prepared by shrinking a unidirectional veneer with partial substances removed in at least one direction; partial the substances include lignin and hemicellulose; and the thickness of the unidirectional wood fiber paper is smaller than or equal to 0.6 mm. Compared with related technology, the unidirectional wood fiber paper provided by the present disclosure is small in thickness and excellent in mechanical performance, has anisotropy and is composed of 100% pure natural materials; and the unidirectional wood fiber paper has a densification effect in the thickness direction by shrinkage, moreover, the transverse binding force and compactness of the unidirectional wood fiber paper are improved, thereby reducing transverse cracking of the unidirectional wood fiber paper.

### CROSS-REFERENCE TO RELATED APPLICATIONS

The disclosure claims the benefits of priority to PCT Application No. PCT/CN2024/132395, filed on Nov. 15, 2024, which claims the benefits of priority to Chinese Patent Application No. 22024101716440, entitled “Wood fiber reinforced material, and preparation method and use therefor” filed on Feb. 6, 2024, both of which are incorporated herein by reference in their entireties.

### TECHNICAL FIELD

The present disclosure generally relates to a fiber reinforced composite material, and more particularly, to unidirectional wood fiber paper and a preparation method therefor, a unidirectional wood fiber paper prepreg and a preparation method therefor, and a wood fiber paper reinforced composite and a preparation method therefor.

### BACKGROUND

The market of plant fiber prepreg is one of the emerging markets in the field of composites, and with the growing demand for sustainable materials and increasing environmental awareness, the application of plant fiber prepregs in multiple industries is gaining more attention. However, compared with traditional synthetic fibers, the plant fiber prepreg still has high production cost, and its performance is lower than that of artificial fibers, which affects market promotion. One of the main reasons is that plant fibers in nature, especially hemp with good performance, are short fibers (centimeter level); a continuous (several meters or even longer) plant fiber prepreg can be produced by a complex production process, for example, a hemp fiber prepreg with good performance at present is produced by the production processes of: harvesting, retting, breaking, scutching, hackling, modifying, drying, laying, and arranging, and impregnating with resin, there are several mechanical actions in the production process, which cause inevitable damage to the strength of the fibers. Moreover, there are many processes, resulting in high cost.

As a kind of plant fiber, wood fibers are longer, and theoretically longer plant fibers can be obtained, but the performance thereof needs to be improved. In the last ten years or so, the industry and scholars have proposed some public technologies to improve the performance of wood and found that after removing a certain amount of lignin from the wood by chemical treatment, the wood will have good compressibility. Further, a wood structure with excellent mechanical properties can be obtained by applying pressure on the wood in one direction (thickness direction). However, it is difficult to directly apply to the production and processing of a unidirectional veneer prepreg in the related technology. There are several reasons. First, the current wood chemical treatment is still in the laboratory principle stage, it needs a long cycle and high energy consumption to achieve a high lignin removal ratio. Second, the current public technology is actually to treat and process thicker wood slabs, once the thickness of the treated unidirectional wood is low to a certain extent (such as ≤0.8 mm, hereinafter referred to as the unidirectional veneer), the unidirectional veneer subjected to chemical treatment is easy to face transverse cracking and poor transverse mechanical properties in a compressing direction, and there is no solution to solve this problem in the related technology. Third, the unidirectional veneer subjected to chemical treatment is very prone to wrinkles during the drying and dewatering process (this is generally not a problem for thick wood slabs), so it is also necessary to consider how to quickly drain the water from the wood while being dense and ensure the flatness of the wood.

### SUMMARY OF THE DISCLOSURE

In view of this, in order to solve the technical problem, the present disclosure provides unidirectional wood fiber paper with excellent mechanical property and high flatness and a preparation method therefor, a unidirectional wood fiber paper prepreg and a preparation method therefor, and a wood fiber paper reinforced composite and a preparation method therefor.

The present disclosure provides unidirectional wood fiber paper, being prepared by shrinking a unidirectional veneer with partial substances removed in at least one direction, wherein partial substances comprise lignin and hemicellulose; and the thickness of the unidirectional wood fiber paper is smaller than or equal to 0.6 mm.

In some embodiments, the apparent thickness of the unidirectional wood fiber paper under a pressure not larger than 0.005 MPa is not greater than 4 times of the average thickness of the unidirectional wood fiber paper.

In some embodiments, the unidirectional wood fiber paper comprises wood fibers and/or fiber bundles, the wood fibers and/or the fiber bundles are integrally arranged or extend in a single direction on a microscopic scale.

In some embodiments, the density of the unidirectional wood fiber paper ranges from 0.8 g/cm³ to 1.5 g/cm³; and/or, the areal density of the unidirectional wood fiber paper ranges from 20 g/m² to 400 g/m²; and/or, the tensile strength of the unidirectional wood fiber paper in a direction parallel to the wood fibers ranges from 150 MPa to 1000 MPa.

In some embodiments, the thickness of the unidirectional wood fiber paper ranges from 0.03 mm to 0.6 mm; and/or, the Young's modulus of the unidirectional wood fiber paper in the direction parallel to the wood fibers preferably ranges from 20 GPa to 80 GPa.

In some embodiments, the thickness of the unidirectional veneer is less than or equal to 0.8 mm; and/or, the shrinkage comprises transverse shrinkage and thickness shrinkage according to force decomposition.

In some embodiments, the unidirectional veneer with partial substances removed shrinks in at least two directions; the shrinkage comprises transverse shrinkage and thickness shrinkage; and a direction of a shrinkage force of the transverse shrinkage intersects with a direction of a shrinkage force of the thickness shrinkage.

In some embodiments, the unidirectional veneer with partial substances removed comprises wood fibers and/or fiber bundles; the wood fibers and/or the fiber bundles are integrally arranged or extend in a single direction on a microscopic scale; the shrinkage force of the transverse shrinkage is the force parallel to the unidirectional veneer, and the force is in direction intersected with the extending direction of the wood fibers and/or fiber bundles in the plane; and/or, the shrinkage force of thickness shrinkage is the force in the direction vertical to the unidirectional veneer; and the force in the horizontal direction and the force in the vertical direction are each an originally applied force independent from each other, and/or, forces formed by the combination or decomposition of forces.

In some embodiments, the apparent thickness of the unidirectional wood fiber paper under the pressure of 0.005 MPa does not exceed 3 times of the average thickness of the unidirectional wood fiber paper; and/or, all and/or part of the unidirectional wood fiber paper has smooth plastic feeling; and/or, when the thickness of the unidirectional wood fiber paper is less than 0.15 mm, the light transmittance of all and/or part of the unidirectional wood fiber paper ranges from 2% to 70%.

In some embodiments, the weight loss of unidirectional veneer with partial substances removed ranges from 10% to 60% relative to the unidirectional veneer; and/or, the transverse shrinkage ratio ranges from 2% to 40%; and the thickness shrinkage ratio ranges from 20% to 90%.

The present disclosure further provides a preparation method for unidirectional wood fiber paper, comprising the following steps: S1) chemically modifying a unidirectional veneer to obtain a unidirectional veneer with partial substances removed; and S2) performing shrinkage treatment on the unidirectional veneer with partial substances removed in at least one direction to obtain the unidirectional wood fiber paper; and the shrinkage comprises transverse shrinkage and thickness shrinkage according to force decomposition.

In some embodiments, a thickness of the unidirectional veneer ranges from 0.05 mm to 0.8 mm; and/or, an areal density of the unidirectional veneer ranges from 20 g/m² to 450 g/m²; and/or, the chemical modification in S1) is performed in a closed high-pressure system; a target temperature of chemical modification ranges from 100° C. to 150° C.; the target pressure of chemical modification ranges from 0.07 MPa to 1.9 MPa; the chemical modification is maintained in the target temperature/pressure for 1 hour to 12 hours; or, the chemical modification is performed under normal pressure; the chemical modification is maintained in the target temperature/pressure for 24 hours to 72 hours; the temperature of chemical modification is the temperature at which water boils without elevated pressures; and/or, after chemical modification is performed, a reaction solution is cooled, thus obtaining the unidirectional veneer with partial substances removed.

In some embodiments, in step S1), a modification solution for chemical modification comprises an alkaline substance, a sulfonating agent and water; the pH value of the modification solution ranges from 12 to 14; the concentration of the alkaline substance in the modification solution ranges from 0.01 kg/L to 5 kg/L; the alkaline substance is one or more selected from sodium hydroxide, potassium hydroxide, sodium bicarbonate, and potassium bicarbonate; the concentration of the sulfonating agent in the modification solution ranges from 0.01 kg/L to 5 kg/L; the sulfonating agent in the modification solution is one or more selected from sulfite, chlorosulfonic acid, hydroxymethylsulfonate, sulfuryl chloride, and sulfamic acid; and/or, the material ratio of the unidirectional veneer and the modification solution for chemical modification ranges from 4.6 cm³: 1 L to 184 cm³: 1 L; and/or, compared with the unidirectional veneer, the mass of the unidirectional veneer with partial substances removed is reduced by 10%-60%.

In some embodiments, the unidirectional veneer is placed in a material frame for chemical modification; the material frame comprises a frame body, a partition plate, and a frame cover; the partition plate is arranged in the frame body; and the side wall of the frame body, the bottom of the frame body, the partition plate, and the frame cover are all provided with holes.

In some embodiments, the material frame is a cylindrical material frame; a plurality of partition plates are provided; and the plurality of partition plates are arranged in concentric circles within the frame body.

In some embodiments, the material frame is a cuboid material frame; a plurality of partition plates are provided; and the plurality of partition plates are arranged in parallel within the material frame.

In some embodiments, the shrinkage treatment comprises transverse shrinkage treatment and thickness shrinkage treatment; and the force of the transverse shrinkage treatment is intersected with the force of the thickness shrinkage treatment.

In some embodiments, the transverse shrinkage treatment comprises applying an external mechanical force and/or performing dehydration spontaneous shrinkage in the transverse direction; and the external mechanical force applied in the transverse direction is in a direction intersected with the extending direction of the wood fibers and/or fiber bundles of the unidirectional veneer with partial substances removed in the plane.

In some embodiments, applying the external mechanical force in the transverse direction comprises applying and attaching a film capable of performing transverse shrinkage to the surface of unidirectional veneer with partial substances removed, and after applying the pressure, the film material is removed; and/or, roller rubbing treatment is performed on the unidirectional veneer with partial substances removed; and/or, pressure is transversely applied to the unidirectional veneer with partial substances removed.

In some embodiments, a pressure for applying the external mechanical force in the transverse direction ranges from 0.001 MPa to 1.5 MPa; and/or, the temperature of the transverse shrinkage treatment ranges from 15° C. to 150° C.; and/or, the time of the transverse shrinkage treatment ranges from 1 second to 4 minutes.

In some embodiments, the thickness shrinkage comprises hot-pressing treatment under a negative pressure condition; the pressure of the hot-pressing treatment ranges from 0.1 MPa to 60 MPa; and/or, the temperature of the hot-pressing treatment ranges from 50° C. to 150° C.; and/or, the time of the hot-pressing treatment ranges from 0.5 minutes to 20 minutes.

In some embodiments, the thickness shrinkage is performed on a single or stacked veneers; a number of stacked veneers ranges from 2 to 20; and the pressure of the thickness shrinkage treatment in the stacked condition ranges from 0.1 MPa to 60 MPa.

In some embodiments, the transverse shrinkage ratio ranges from 2% to 40%; and/or, the thickness shrinkage ratio ranges from 20% to 90%.

In some embodiments, splicing is carried out before or after shrinkage treatment; and the splicing is specifically to mark splicing contours on the unidirectional veneer with partial substances removed or the wood fiber paper subjected to shrinkage treatment, and then splice the corresponding parts.

The present disclosure further provides a preparation method for unidirectional wood fiber paper, comprising the following steps: A1) chemically modifying a unidirectional veneer to obtain a unidirectional veneer with partial substances removed; and A2) performing shrinkage treatment and levelling treatment on the unidirectional veneer with partial substances removed in at least one direction to obtain the unidirectional wood fiber paper; and the levelling treatment is to perform planar hot pressing in a negative pressure air pumping environment.

In some embodiments, exhaust channels are arranged on two contact surfaces or a single contact surface of the unidirectional wood fiber paper during levelling treatment.

In some embodiments, the pressure of planar hot pressing ranges from 0.01 MPa to 2 MPa; and/or, the time of the levelling treatment ranges from 0.1 min to 4 min; and/or, the temperature of the levelling treatment ranges from 40° C. to 150° C.

In some embodiments, the levelling treatment is one or more selected from vacuum thermoforming and negative-pressure hot-pressing treatment; and/or, the water content of the unidirectional wood fiber paper is less than or equal to 10 wt %.

In some embodiments, the shrinkage treatment comprises transverse shrinkage treatment and thickness shrinkage treatment; the thickness shrinkage treatment is to apply a mechanical pressure in the thickness direction; the pressure for applying the mechanical pressure in the thickness direction ranges from 0.01 MPa to 80 MPa; and/or, the time of the thickness shrinkage treatment ranges from 0.1 min to 3 min; and/or, the temperature of the thickness shrinkage treatment ranges from 15° C. to 150° C.

The present disclosure further provides a unidirectional wood fiber paper prepreg, the unidirectional wood fiber paper and a polymer layer attached to at least one surface of the unidirectional wood fiber paper.

In some embodiments, the mass of the polymer layer ranges from 5% to 85% of the mass of the unidirectional wood fiber paper prepreg; and/or, the thickness ratio of the polymer layer to the unidirectional wood fiber paper ranges from (5:1) to (0.05:1); and/or, the areal density of the unidirectional wood fiber paper prepreg ranges from 30 g/m² to 500 g/m²; and/or, the thickness of the unidirectional wood fiber paper prepreg ranges from 0.03 mm to 0.7 mm.

In some embodiments, the polymer layer comprises a thermoplastic polymer and/or a thermosetting polymer; and the gram weight of the polymer layer ranges from 5 g/m² to 200 g/m².

The present disclosure further provides a preparation method for a unidirectional wood fiber paper prepreg, comprising the following steps: transferring a polymer to at least one surface of the unidirectional wood fiber paper to obtain the unidirectional wood fiber paper prepreg; and the transfer method is one or more selected from film-lamination, printing, infiltration and coating.

The present disclosure further provides a wood fiber paper reinforced composite, comprising a plurality of layers of the unidirectional wood fiber paper; and adjacent unidirectional wood fiber paper is bonded through the polymer.

In some embodiments, the tensile strength of the wood fiber paper reinforced composite ranges from 130 MPa to 1000 MPa; and/or, the flexural strength of the wood fiber paper reinforced composite ranges from 130 MPa to 1000 MPa; and/or, the Young's modulus of the wood fiber paper reinforced composite ranges from 12 GPa to 75 GPa.

In some embodiments, the thickness of one layer of wood fiber paper in the wood fiber paper reinforced composite ranges from 0.02 mm to 0.6 mm; and/or, the layered distribution of the wood fiber paper reinforced composite is clearly visible in the longitudinal cross-section; and/or, the volume fraction of the wood fiber paper in the wood fiber paper reinforced composite ranges from 40% to 99%.

In some embodiments, at least one surface of the wood fiber paper reinforced composite is provided with a waterproof polymer layer.

The present disclosure further provides a preparation method for a wood fiber paper reinforced composite, comprising the following steps: stacking, gluing and curing the unidirectional wood fiber paper to obtain the wood fiber paper reinforced composite; and/or, stacking, gluing and curing the unidirectional wood fiber paper prepreg to obtain the wood fiber paper reinforced composite.

The present disclosure further provides a method for shrinkage of a unidirectional veneer, comprising: performing shrinkage treatment on the unidirectional veneer in at least one direction; and decomposition of the shrinkage force comprises transverse shrinkage and thickness shrinkage.

In some embodiments, the unidirectional veneer is subjected to chemical treatment firstly to remove partial substances, and then subjected to shrinkage treatment in the at least one direction.

In some embodiments, shrinkage comprises transverse shrinkage and thickness shrinkage; and directions of the shrinkage force for the transverse shrinkage and thickness shrinkage intersect.

In some embodiments, the unidirectional veneer comprises wood fibers and/or fiber bundles; the wood fibers and/or the fiber bundles are integrally arranged or extend in a single direction on a microscopic scale; the shrinkage force of transverse shrinkage is the force in the direction parallel to the unidirectional veneer, and is in a direction intersected with the extending direction of the wood fibers and/or fiber bundles of the unidirectional veneer in the plane; and/or, the shrinkage force of thickness shrinkage is the force in the direction vertical to the unidirectional veneer; and the force in the horizontal direction and the force in the vertical direction are each an originally applied force independent from each other, and/or, forces formed by the combination or decomposition of forces.

In some embodiments, the thickness shrinkage comprises hot-pressing treatment under a negative pressure condition; the pressure of the hot-pressing treatment ranges from 0.1 MPa to 60 MPa; and/or, the temperature of the hot-pressing treatment ranges from 50° C. to 150° C.; and/or, the time of the hot-pressing treatment ranges from 0.5 min to 20 min.

The present disclosure further provides a wood hollow tube, being prepared from the above unidirectional wood fiber paper, the unidirectional wood fiber paper prepreg, or the wood fiber reinforced composite.

The present disclosure provides unidirectional wood fiber paper. The unidirectional wood fiber paper is formed by shrinking a unidirectional veneer with partial substances removed in at least one direction; partial the substances include lignin and hemicellulose; the thickness of the unidirectional wood fiber paper is smaller than or equal to 0.6 mm; and the apparent thickness of the unidirectional wood fiber paper under a pressure not larger than 0.005 MPa is not greater than 4 times of the average thickness of the unidirectional wood fiber paper. Compared with related technology, the unidirectional wood fiber paper provided by the present disclosure is small in thickness and excellent in mechanical performance, has anisotropy and is composed of 100% pure natural materials; and the unidirectional wood fiber paper has the densification effect in the thickness direction by shrinkage, moreover, the transverse binding force and compactness of the unidirectional wood fiber paper are improved, thereby reducing transverse cracking of the unidirectional wood fiber paper.

Further, the present disclosure provides a unidirectional wood fiber paper prepreg which is similar to a fiber prepreg (such as a glass fiber prepreg and a carbon fiber prepreg) in the conventional composite industry, so that the product applicability is wide; moreover, the feedstock of the unidirectional wood fiber prepreg is high-performance unidirectional wood fiber paper, so it is green and environment-friendly; and a plurality of unidirectional wood fiber paper prepregs can be simply stacked and less pressure is applied to obtain a product, and the convenience of use is ensured.

Further, the present disclosure provides a wood fiber paper reinforced composite, which is layering laminated and has high mechanical properties.

Further, a surface of the wood fiber paper reinforced composite provided by the present disclosure is a polymer with waterproof performance, so that the wood fiber paper reinforced composite has high waterproof performance.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a microgram of unidirectional wood fiber paper, according to some embodiments of the present disclosure.

FIG. 2 is a physical object image of unidirectional wood fiber paper, according to some embodiments of the present disclosure.

FIG. 3 is a schematic diagram of a preparation flow of unidirectional wood fiber paper, according to some embodiments of the present disclosure.

FIG. 4 is a structural schematic diagram of a material frame for a vertical reactor, according to some embodiments of the present disclosure.

FIG. 5 is a schematic diagram of a unidirectional veneer placed in a vertical reactor, according to some embodiments of the present disclosure.

FIG. 6 is a structural schematic diagram of a material frame for a horizontal reactor, according to some embodiments of the present disclosure.

FIG. 7 is a schematic diagram of a unidirectional veneer placed in a horizontal reactor, according to some embodiments of the present disclosure.

FIG. 8 is an object diagram of cracks generated by unidirectional shrinkage in a thickness direction, according to some embodiments of the present disclosure.

FIG. 9 is a schematic diagram of sinking and shrinkage of a tube cavity of wood fiber paper pipe in spontaneous transverse shrinkage, according to some embodiments of the present disclosure.

FIG. 10 is an object diagram of a unidirectional wood fiber paper in spontaneous transverse shrinkage, according to some embodiments of the present disclosure.

FIG. 11 is a schematic diagram of continuous hot pressing processing of a hot roll, according to some embodiments of the present disclosure.

FIG. 12 is a schematic diagram of continuous hot pressing processing of a continuous flat press, according to some embodiments of the present disclosure.

FIG. 13 is a schematic diagram of continuous hot pressing processing of a belt press, according to some embodiments of the present disclosure.

FIG. 14 is a schematic diagram of splicing of unidirectional wood fiber paper, according to some embodiments of the present disclosure.

FIG. 15 is a schematic diagram of levelling by plastic forming, according to some embodiments of the present disclosure.

FIG. 16 is a preparation process of a unidirectional wood fiber paper prepreg, according to some embodiments of the present disclosure.

FIG. 17 is a schematic diagram of a single-surface film-lamination work, according to some embodiments of the present disclosure.

FIG. 18 is a schematic diagram of a unidirectional wood fiber paper prepreg prepared by a coating and scraping method, according to some embodiments of the present disclosure.

FIG. 19 is a schematic diagram of a principle of preparing a wood fiber paper reinforced composite with a unidirectional wood fiber paper prepreg, according to some embodiments of the present disclosure.

FIG. 20 is a cross-sectional schematic diagram of a wood fiber paper reinforced composite, according to some embodiments of the present disclosure.

FIG. 21 is a schematic diagram of preparing a wood fiber paper reinforced composite with waterproof performance by a unidirectional wood fiber paper prepreg, according to some embodiments of the present disclosure.

FIG. 22 is a flowchart of preparing a wood fiber paper reinforced composite with unidirectional wood fiber paper, according to some embodiments of the present disclosure.

FIG. 23 is an object diagram of a wood hollow tube, according to some embodiments of the present disclosure.

FIG. 24 is a photo of a unidirectional veneer with partial substances removed in a wet state as recited in Example 1, according to some embodiments of the present disclosure.

FIG. 25 is a diagram of spontaneous transverse shrinkage of a unidirectional veneer with partial substances removed as recited in Example 1, according to some embodiments of the present disclosure.

FIG. 26 is a curve diagram of a tensile stress strain test in a fiber direction of unidirectional wood fiber paper as recited in Example 1, according to some embodiments of the present disclosure.

FIG. 27 illustrates object diagrams of a unidirectional veneer shrinking in a thickness direction only after chemical treatment and shrinking in a width direction only after chemical treatment respectively as recited in Comparative Example 1, according to some embodiments of the present disclosure.

FIG. 28 illustrates photos of unidirectional wood fiber paper prepared with different stacking widths as recited in Example 10, according to some embodiments of the present disclosure.

FIG. 29 is an overlook view of a wood fiber reinforced epoxy resin-based composite as recited in Example 11, according to some embodiments of the present disclosure.

FIG. 30 is a side view of a wood fiber reinforced epoxy resin-based composite as recited in Example 11, according to some embodiments of the present disclosure.

FIG. 31 is a diagram of a transmittance test of unidirectional wood fiber paper as recited in Example 15, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms or definitions incorporated by reference.

The present disclosure provides unidirectional wood fiber paper. The unidirectional wood fiber paper is formed by shrinking a unidirectional veneer with partial substances removed in at least one direction. The partial substances include lignin and hemicellulose. A thickness of the unidirectional wood fiber paper is smaller than or equal to 0.6 mm; the thickness of the unidirectional wood fiber paper is less than that of the unidirectional veneer. An apparent thickness of the unidirectional wood fiber paper under a pressure not larger than 0.005 MPa is not greater than 4 times of the average thickness of the unidirectional wood fiber paper.

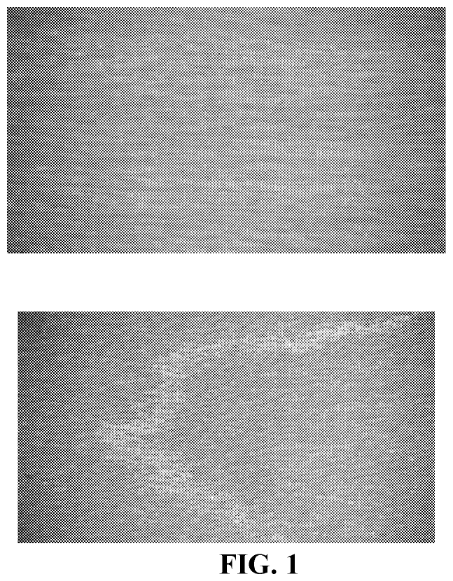

According to the present disclosure, the unidirectional wood fiber paper preferably includes wood fibers and/or fiber bundles. The wood fibers and/or the fiber bundles are integrally arranged or extend in a single direction on a microscopic scale, specifically, 70% or more of the wood fibers and/or the fiber bundles are arranged or extend in the single direction on a microscopic scale, and further, specifically, 80% or more of the wood fibers and/or the fiber bundles are arranged or extend in the single direction on a microscopic scale. FIG. 1 is a microgram of unidirectional wood fiber paper, according to some embodiments of the present disclosure.

In the composite material, one way refers to that all or most fibers extend in the single parallel direction, and it can also be called as non-patterns. Because the wood fiber paper provided by the present disclosure is different from a conventional composite fiber cloth, the wood fiber paper does not have independent fiber characteristic. However, in microstructure, the wood fiber paper includes continuous wood fibers, and these wood fibers are connected by chemical components that are naturally generated in natural wood, so a physical form of single paper is presented in the macroscopic aspect. The arrangement of these continuous wood fibers conforms to the definition of the one way of a conventional composite, and therefore it is called as the unidirectional wood fiber paper in the present disclosure.

According to the present disclosure, the tensile strength of the unidirectional wood fiber paper in a direction parallel to the wood fibers preferably ranges from 150 MPa to 1000 MPa, and optionally, the tensile strength of the unidirectional wood fiber paper in the direction parallel to the wood fibers is 150 MPa, 200 MPa, 250 MPa, 300 MPa, 350 MPa, 400 MPa, 500 MPa, 600 MPa, 700 MPa, 800 MPa, 900 MPa, 1000 MPa, or a range between any two of the above values. The Young's modulus of the unidirectional wood fiber paper in the direction parallel to the wood fibers preferably ranges from 20 GPa to 80 GPa, and optionally, the Young's modulus of the unidirectional wood fiber paper in the direction parallel to the wood fibers is 20 GPa, 25 GPa, 30 GPa, 35 GPa, 40 GPa, 45 GPa, 50 GPa, 55 GPa, 60 GPa, 65 GPa, 70 GPa, 75 GPa, 80 GPa, or a range between any two of the above values. Therefore, the wood fiber paper has good tensile strength and deformation resistance. In the present disclosure, the terms “Young's modulus” and “tensile modulus” refer to the same physical property parameter of a material, namely the ratio of stress to strain along the axial direction during tensile testing within the elastic deformation stage. To facilitate description and maintain consistency in terminology, the term “Young's modulus” is uniformly used throughout this specification.

The unidirectional wood fiber paper provided by the present disclosure has high flatness, specifically, the apparent thickness of the unidirectional wood fiber paper under the pressure not greater than 0.005 MPa does not exceed 4 times of the average thickness of the unidirectional wood fiber paper.

Further, in some embodiments, the apparent thickness of the unidirectional wood fiber paper under the pressure of 0.005 MPa preferably does not exceed 3 times of the average thickness of the unidirectional wood fiber paper.

Moreover, it can be understood that the apparent thickness is related to pressure, and the greater the pressure, the smaller the apparent thickness, and the smaller the multiple between the apparent thickness and the average thickness, so the description of flatness can also be equivalent to the above description.

In some embodiments, a flatness testing method includes: putting unidirectional wood fiber paper between two plane objects, and applying pressure to the planes to enable the unidirectional wood fiber paper to be subjected to a smaller pressure, in which, the flat wood fiber paper will incline to be fitted with the pressure-applied plane, and the difference value between the highest point and the lowest point of the pressed unidirectional wood fiber paper is the apparent thickness of the unidirectional wood fiber paper. The average thickness of the unidirectional wood fiber paper is the thickness average value, measured by a micrometer, of different position points of the unidirectional wood fiber paper.

According to the present disclosure, the unidirectional wood fiber paper is prepared by removing partial substances of the unidirectional veneer by chemical modification and shrinking in at least one direction. In the present disclosure, unidirectional wood in the nature is utilized to produce the unidirectional wood fiber paper. Fibers of the unidirectional wood grow along the longitudinal direction of a trunk, and the fibers are arranged closely and consistently to form a linear characteristic of parallel arrangement. The unidirectional wood is adopted as the feedstock, thus the common procedures of harvesting, retting, breaking, scotching, hackling, and laying and arranging for bast fibers at present are saved. The continuous and unidirectional arranged plant fibers are directly realized, the prepreg manufacturing cost can be greatly saved, and the excellent performance of the wood fiber prepreg can be improved by chemical treatment on the wood and subsequent operation. In the present disclosure, the thickness of the unidirectional veneer is less than or equal to 0.8 mm, further ranges from 0.05 mm to 0.8 mm, and optionally, the thickness of the unidirectional veneer can be 0.05 mm, 0.1 mm, 0.2 mm, 0.3 mm, 0.4 mm, 0.5 mm, 0.6 mm, 0.7 mm, 0.8 mm, 1 mm, or a range between any two of the above values. In some embodiments, the unidirectional veneer with the thickness of 0.28 mm is taken as an example for description; the areal density of the unidirectional veneer preferably ranges from 20 g/m² to 450 g/m², more preferably ranges from 70 g/m² to 200 g/m²; and optionally, the areal density of the unidirectional veneer is 20 g/m², 50 g/m², 70 g/m², 80 g/m², 90 g/m², 100 g/m², 110 g/m², 120 g/m², 130 g/m², 150 g/m², 180 g/m², 200 g/m², 250 g/m², 280 g/m², 300 g/m², 320 g/m², 350 g/m², 400 g/m², 420 g/m², 450 g/m², or a range between any two of the above values. Generally, the thicker the unidirectional veneer, the greater the areal density; the greater the areal density, the greater the thickness; and the greater the thickness, the greater the rigidity of the material, so that the material has better sound insulation.

According to the present disclosure, the weight loss of the unidirectional veneer with partial substances removed preferably ranges from 10% to 60% relative to the unidirectional veneer; optionally, the weight loss of the unidirectional veneer with partial substances removed relative to the unidirectional veneer is 10%, 20%, 25%, 30%, 35%, 40%, 45%, 50%, 55%, 60%, or a range between any two of the above values; and the partial substances include lignin and hemicellulose.

According to the present disclosure, the shrinkage in the at least one direction includes transverse shrinkage and thickness shrinkage according to force decomposition.

In some embodiments, the shrinkage in the at least one direction specifically involves shrinkage in at least two directions. The shrinkage includes the transverse shrinkage and the thickness shrinkage; and the shrinkage force directions of the transverse shrinkage and the thickness shrinkage intersect.

In some embodiments, the shrinkage is bidirectional shrinkage; and the bidirectional shrinkage includes transverse shrinkage and thickness shrinkage, namely the unidirectional veneer with partial substances removed is subjected to bidirectional shrinkage to obtain the unidirectional wood fiber paper.

In some embodiments, the transverse shrinkage ratio preferably ranges from 2% to 40%; optionally, the transverse shrinkage ratio is 2%, 5%, 10%, 15%, 20%, 25%, 30%, 35%, 40%, or a range between any two of the above values. With the transverse shrinkage ratio increasing, the tensile strength and modulus of the finally obtained unidirectional wood fiber paper in the direction vertical to the fiber direction have the increasing tendency; and therefore, it can be selected according to needs.

In some embodiments, the thickness shrinkage ratio preferably ranges from 20% to 90%, more preferably ranges from 20% to 86%; optionally, the thickness shrinkage ratio is 20%, 25%, 30%, 35%, 40%, 45%, 50%, 55%, 60%, 65%, 70%, 75%, 80%, 85%, 86%, 90%, or a range between any two of the above values. The higher the thickness shrinkage ratio is, the thinner the unidirectional wood fiber paper is, and the tensile strength and modulus in the fiber direction have the increasing tendency; and therefore, it can be selected according to needs.

In some embodiments, the shrinkage force directions of transverse shrinkage and thickness shrinkage intersect; and the crossed angle preferably ranges from 60° to 90°.

In some embodiments, the unidirectional veneer with partial substances removed includes wood fibers and/or fiber bundles; the wood fibers and/or the fiber bundles are integrally arranged or extend in a single direction on a microscopic scale, and the force is in a direction intersected with the extending direction of the wood fibers and/or fiber bundles in the plane. The in-plane intersection is also in a direction vertical to the fiber direction in the macroscopic aspect. The shrinkage force of transverse shrinkage is the force in the direction parallel to the unidirectional veneer; and/or, the shrinkage force of thickness shrinkage is the force in the direction vertical to the unidirectional veneer; and the force in the horizontal direction and the force in the vertical direction are each an originally applied force independent from each other, and/or, forces formed by the combination or decomposition of forces.

Both the thickness and density of the unidirectional wood fiber paper obtained by shrinkage in at least two directions can be changed. The thickness of the unidirectional wood fiber paper is smaller than that of the unidirectional veneer, and preferably ranges from 10% to 80% of the thickness of the unidirectional veneer; and optionally, the thickness of the unidirectional wood fiber paper can be 10%, 15%, 20%, 25%, 30%, 35%, 40%, 45%, 50%, 55%, 60%, 65%, 70%, 75%, and 80%, of the thickness of the unidirectional veneer or a range between any two of the above values.

In some embodiments, the thickness of the unidirectional wood fiber paper is smaller than or equal to 0.6 mm; and optionally, the thickness of the unidirectional wood fiber paper is 0.01 mm, 0.05 mm, 0.1 mm, 0.15 mm, 0.2 mm, 0.25 mm, 0.35 mm, 0.4 mm, 0.45 mm, 0.5 mm, 0.55 mm, and 0.6 mm, or a range between any two of the above values.

In some embodiments, the density of the unidirectional wood fiber paper ranges from 0.8 g/cm³ to 1.5 g/cm³; and optionally, the density of the unidirectional wood fiber paper is 0.8 g/cm³, 0.9 g/cm³, 1.0 g/cm³, 1.1 g/cm³, 1.2 g/cm³, 1.3 g/cm³, 1.4 g/cm³, and 1.5 g/cm³, or a range between any two of the above values.

In some embodiments, the areal density of the unidirectional wood fiber paper ranges from 20 g/m² to 400 g/m²; and optionally, the areal density of the unidirectional wood fiber paper is 20 g/m², 25 g/m², 30 g/m², 40 g/m², 50 g/m², 60 g/m², 70 g/m², 80 g/m², 90 g/m², g/m², 110 g/m², 120 g/m², 130 g/m², 150 g/m², 160 g/m², 170 g/m², 180 g/m², 190 g/m², 200 g/m², 220 g/m², 250 g/m², 280 g/m², 300 g/m², 320 g/m², 350 g/m², 380 g/m², 400 g/m², or a range between any two of the above values.

According to the present disclosure, the feedstock of the unidirectional wood fiber paper is natural wood, and it is 100% natural material.

According to the present disclosure, the unidirectional wood fiber paper can be spliced to infinite width and length theoretically, specifically, the length of a single piece of non-spliced unidirectional wood fiber paper preferably ranges from 0.1 m to 5 m, more preferably ranges from 0.1 m to 3 m; and the width of the single piece of non-spliced unidirectional wood fiber paper preferably ranges from 0.01 m to 1 m.

According to the present disclosure, the water content of the unidirectional wood fiber paper is preferably below 10 wt %; and the unidirectional wood fiber paper does not wrinkle when being placed at room temperature.

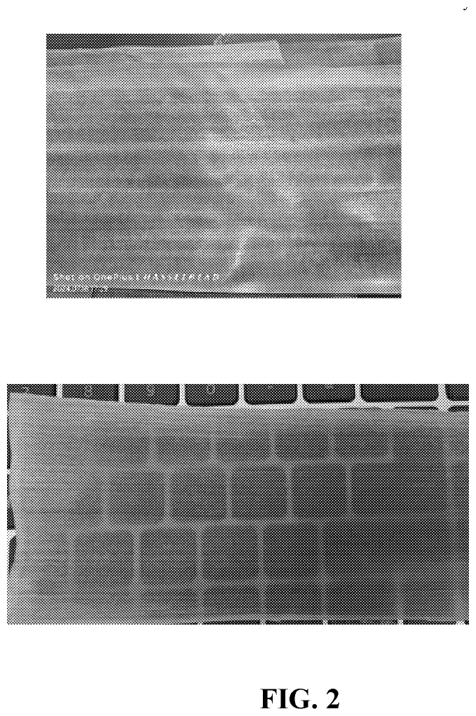

According to the present disclosure, all and/or partial the unidirectional wood fiber paper has smooth plastic feeling. Further, when the thickness of the unidirectional wood fiber paper is less than 0.15 mm, partial area has a light transmission effect, specifically, the light transmittance of all and/or partial the unidirectional wood fiber paper preferably ranges from 2% to 70%. FIG. 2 is an object figure of unidirectional wood fiber paper, according to some embodiments of the present disclosure.

The present disclosure also provides a preparation method for the unidirectional wood fiber paper, which includes the following steps: S1) chemically modifying a unidirectional veneer to obtain a unidirectional veneer with partial substances removed; and S2) performing shrinkage treatment on the unidirectional veneer with partial substances removed in at least one direction to obtain the unidirectional wood fiber paper; and the shrinkage includes transverse shrinkage and thickness shrinkage according to force decomposition.

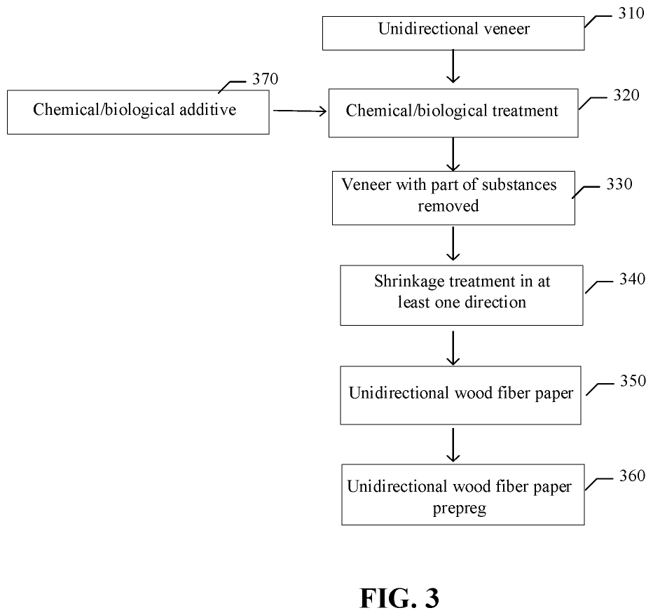

FIG. 3 is a schematic diagram of a preparation flow of unidirectional wood fiber paper, according to some embodiments of the present disclosure.

The present disclosure does not have special restrictions on the source of all feedstocks, which are commercially available.

In the present disclosure, the unidirectional veneer can be of the type well known to those skilled in the field, and there is no special restriction. In the present disclosure, it includes but is not limited to walnut, oak, basswood, red sandalwood, ebony, teak, rosewood, catalpa wood, Microberlinla sp, cherry wood, phellem, poplar, beech, Cassia bakeriana Craib, Pinus sylvestris, maple, white wax wood, and the like. The unidirectional veneer is a natural veneer instead of an artificial scientific wood doped with too many polymer materials. The artificial scientific wood is not environmentally friendly, and its structure will be separated in subsequent chemical reaction. The material of the natural veneer is green and environment-friendly. Cellulose, hemicellulose and lignin are mutually crosslinked in a naturally formed structure, so that the structural integrity can be kept in the subsequent chemical reaction. The wood fibers of the unidirectional veneer are regularly arranged, basically all the wood fibers are arranged in the same direction, and the surface textures are also in the same direction, so the veneer has high anisotropy. The reason for selecting the unidirectional veneer rather than the veneer with other fiber directions is that relatively high internal stress will be released in the subsequent process, only the unidirectional veneer can maintain relatively good overall size consistency, and moreover, defects are not easily caused. In subsequent chemical reaction process, some substances in the wood will be removed from the structure, consequently, the wood will have an internal stress for shrinkage after the reaction. The removed substances are mainly concentrated among the wood fibers, so the internal stress release of the unidirectional veneer after the chemical reaction will be concentrated in one direction, the veneer will uniformly shrink from outside to inside in the direction vertical to the wood fibers, and therefore, the veneer does not easily have defects. If other non-unidirectional veneer with irregular fiber arrangement is used, the internal stress will be released in different directions, it is easy to have excessive internal stress in local area, and defects such as fractures will occur, resulting in waste. The thickness of the unidirectional veneer is less than or equal to 0.8 mm. In some embodiments, the unidirectional veneer with the thickness of 0.28 mm is taken as an example for description. The size of maximum surface of the unidirectional veneer is preferably 3000 mm×500 mm, and any size can be obtained by cutting within this size range. The areal density of the unidirectional veneer preferably ranges from 20 g/m² to 450 g/m².

Referring to FIG. 3, the unidirectional veneer 310 is chemically modified by chemical/biological treatment 320 to obtain the unidirectional veneer with partial substances removed 330. The pH value of a modification solution (e.g., chemical/biological additive 370) for chemical modification preferably ranges from 12 to 14. The modification solution for chemical modification preferably includes an alkaline substance, a sulfonating agent and water; the alkaline substance is an alkaline substance well known to those skilled in the art, and there is no special limitation, and in the present disclosure, it preferably includes but is not limited to one or more selected from sodium hydroxide, potassium hydroxide, sodium bicarbonate, and potassium bicarbonate; the concentration of alkaline substance in the modification solution preferably ranges from 0.01 kg/L to 5 kg/L, more preferably ranges from 0.05 kg/L to 3 kg/L, and still more preferably ranges from 0.1 kg/L to 2 kg/L. In some embodiments, the concentration of the alkaline substance in the modification solution is specifically 0.1 kg/L, 0.05 kg/L, or 0.145 kg/L; the sulfonating agent is a sulfonating agent well known to those skilled in the art, and there is no special limitation, and in the present disclosure, it preferably includes but is not limited to one or more selected from sulfite, chlorosulfonic acid, hydroxymethylsulfonate, sulfuryl chloride, and sulfamic acid; the sulfite is preferably sodium sulfite. The concentration of the sulfonating agent in the modification solution preferably ranges from 0.01 kg/L to 5 kg/L, more preferably ranges from 0.01 kg/L to 3 kg/L, and still more preferably ranges from 0.01 kg/L to 1 kg/L. In some embodiments, the concentration of the sulfonating agent in the modification solution is specifically 0.05 kg/L, 0.075 kg/L, or 0.072 kg/L. The concentration of the sulfonating agent in the modification solution can be correspondingly increased with the increase of the volume of the reaction solution, so as to make up for the decrease in mass transfer caused by the increase in the scale of chemical reaction. The modification solution can be in any volume, depending on the output demand and the reactor equipment specifications, including but not limited to 500 mL, 2 L, 4 L, 20 L, 100 L, 500 L, 1000 L, 2000 L, 5000 L, 8000 L, 10000 L, etc. The material ratio of the unidirectional veneer to the modification solution for chemical modification preferably ranges from 4.6 cm³: 1 L to 184 cm³: 1 L. The higher the material ratio, the higher the output of a single reaction, so it is generally necessary to increase the material ratio in the reaction as much as possible, but it is also necessary to comprehensively consider the difficulty of mass transfer and the excessive accumulation of materials in a reactor. In the process of reaction, the alkaline substance will react with lignin, hemicellulose and cellulose in the unidirectional veneer. Taking the alkaline substance as sodium hydroxide and the sulfonating agent as sodium sulfite as an example, hemicellulose may react with sodium hydroxide to generate sodium hemicellulose (as shown in a reaction formula 1), and lignin may react with sodium hydroxide and sodium sulfite to generate sodium lignosulfonate (as shown in a reaction formula 2 and a reaction formula 3). By-products of these reactions will be separated from the unidirectional veneer structure and dissolved or suspended in the reaction solution. If the material ratio is too high, the reaction mass transfer efficiency will be reduced, and the reaction by-products are difficult to be uniformly dispersed in the system, which will lead to the reduction of the reaction rate in the local area, resulting in the reduction of the property uniformity of the unidirectional veneer after the reaction, as well as influence on the subsequent process stability and final product performance. Moreover, the excessive accumulation of materials in the reactor will also increase the mutual friction of the unidirectional veneers or the friction with the internal structure of the reactor, resulting in a damage to the unidirectional veneer.

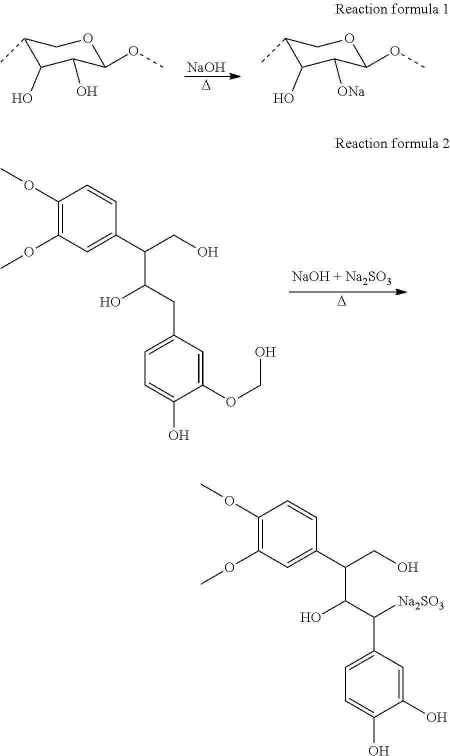

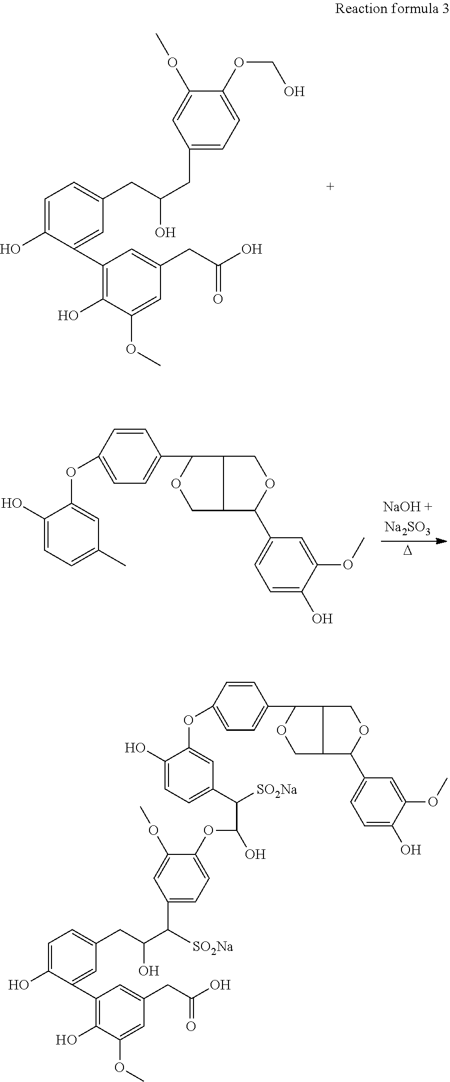

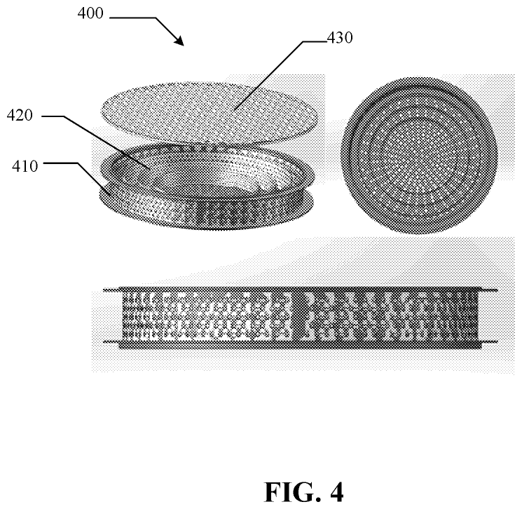

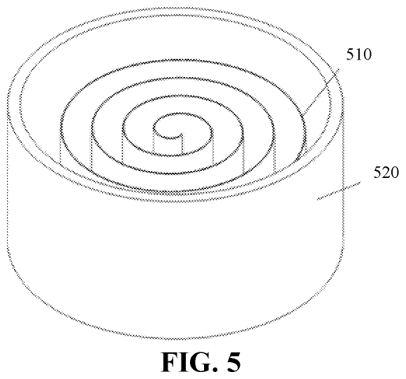

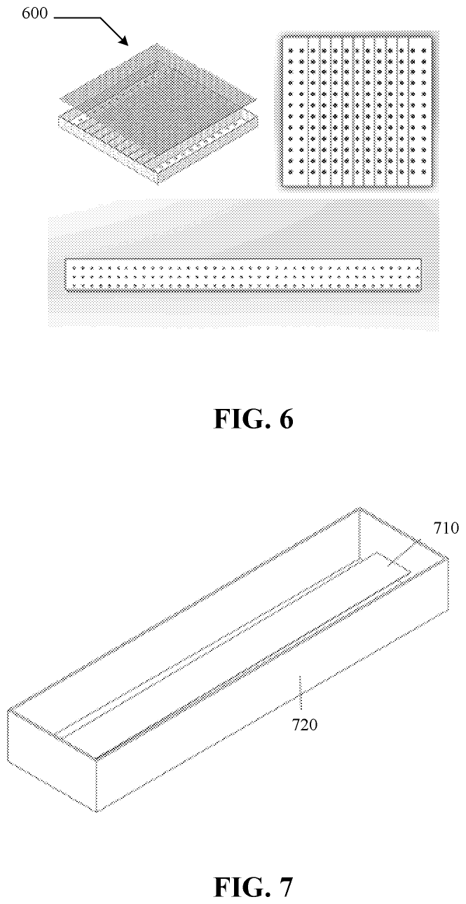

For small-scale reactions below 5 L, mass and heat transfer in the system is relatively easy, and the number of unidirectional veneers is relatively small, and the whole veneer can be curled and attached to the wall of the reactor. For reactions above 5 L, due to the large scale of the reaction, the mass and heat transfer rate in the system will be reduced, and the number of unidirectional veneers is large, so it is necessary to put the unidirectional veneer into the reactor in advance. Moreover, it is necessary to add a step of pre-layering to maximize the use of the internal space of the reactor, and the unidirectional veneer is evenly arranged in all parts in the reactor. In addition, the unidirectional veneer in a single area can also be controlled to a certain number by this partitioning, thus reducing the damage to the unidirectional veneer caused by mutual friction and improving the mass transfer effect. The unidirectional veneer is preferably placed in a material frame for chemical modification. FIG. 4 is a structural schematic diagram of a material frame for a vertical reactor, according to some embodiments of the present disclosure. Referring to FIG. 4, a material frame 400 includes a frame body 410, a partition plate 420, and a frame cover 430. The partition plate 420 is arranged in the frame body 410. The side wall of the frame body 410, the bottom of the frame body 410, the partition plate 420, and the frame cover 430 are all provided with holes. In some embodiments, the material frame is a cylindrical material frame, and a plurality of partition plates are provided. The plurality of partition plates are arranged in concentric circles within the frame body, either at the same intervals or at different intervals. In some embodiments, the material frame is a cuboid material frame; a plurality of partition plates are provided; and the plurality of partition plates are arranged in parallel within the material frame, either at the same interval or at different intervals. In the present disclosure, the unidirectional veneer can be pre-layered with the material frame which is of an upper and lower overlapped type. FIG. 5 is a schematic diagram of a unidirectional veneer placed in a vertical reactor, according to some embodiments of the present disclosure. Referring to FIG. 5, unidirectional veneer 510 is placed in a vertical reactor 520. Referring back to FIG. 4, the main body structure of the material frame 400 is formed by a mesh plate with a certain hole. The diameter of the hole cannot be too small to affect the mass transfer effect, nor too large to lead to scratches on the veneer and reduction of the structural strength. Generally, the diameter of the hole ranges from 3 mm to 5 mm, and the overall hole density of the hole ranges from 4×105 holes/m³ to 3.5×105 holes/m³, which is determined according to the actual working conditions and equipment conditions. The thickness of the corresponding mesh plate needs to meet the structural stability of the frame body after loading the material, and a slab with thickness ranging from 1 mm to 5 mm is generally selected according to the size of the material frame. The height of a single layer is mainly determined by the width of the veneer to be treated, which generally ranges from 10 cm to 30 cm. The radius of the outermost layer and the radius of the innermost layer of the material frame depend on the specific reactor structure and the quantity of materials, and the spacing in the frame is not equidistant, generally increases from the inside to the outside in sequence, and the specific increase depends on the thickness and quantity of the veneer. The basic criterion of this design is that when loading the veneer, it is easy to operate and will not damage the veneer. FIG. 6 is a structural schematic diagram of a material frame 600 for a horizontal reactor, according to some embodiments of the present disclosure, and the overall appearance size of the material frame depends on the structure of the horizontal reactor. The height of the single layer depends on the width of the material, and the thickness depends on the amount of material filled and the size of the material frame. The material frame needs to be designed as a porous structure, the diameter range of the hole generally ranges from 3 mm to 5 mm, and the hole density of the overall hole ranges from 6.8×105 holes/m³ to 5.0×105 holes/m³. The internal partition plate is a perforated mesh plate with thickness of 2 mm, and the partitioning distance can be equidistant, and the distance value is added by 1 cm to 5 cm from the width of the veneer. This allows the material to move freely inside and outside the material frame, and the size of the holes is as large as possible, so that the unidirectional veneer can be effectively layered without affecting mass transfer. The material frame needs to be designed to be close to the inner diameter of the reactor, thus the stacked multi-layer material frame can maximize the use of the space in the reactor, and the material of the material frame are preferably alkali and temperature resistant materials. FIG. 7 is a schematic diagram of a unidirectional veneer placed in a horizontal reactor, according to some embodiments of the present disclosure. As shown in FIG. 7, the unidirectional veneer 710 is placed in the horizontal reactor 720.

The reactor can be vertical or horizontal, heating in the reactor can be in any mode as long as the temperature precision in the system can be controlled to be ±10° C. For a large-volume reactor, mass transfer can be improved by adding methods such as stirring, solution backflow, overall rotating of the reactor, and pumping of a solution by an external circulating pump. In the present disclosure, there are two choices for the reaction temperature and pressure of chemical modification. The first one is that heating is performed under normal pressure until water is in a boiling state, but it is preferably to add a condensation backflow module, which leads to the increase in the reaction energy consumption, in addition, the reaction can be performed completely only when the reaction time under normal pressure, namely, the maintaining time under the target temperature/pressure ranges from 24 hours to 72 hours. In some embodiments, the reaction time under normal pressure can be specifically 48 hours. The second one is that heating is performed in a closed high-pressure system until the temperature exceeds the boiling temperature of water, namely the target temperature preferably ranges from 100° C. to 150° C., more preferably ranges from 110° C. to 150° C., still more preferably ranges from 120° C. to 130° C. and most preferably is 125° C., and the whole system forms a high-pressure system, thus the condensation backflow module is not need to be added. The reaction can be completely performed when the reaction time, namely the maintaining time is reduced to a range of 1 hour to 12 hours, more preferably in a range of 3 hours to 10 hours, still more preferably in a range of 4 hours to 8 hours, and most preferably in a range of 5 hours to 8 hours. Therefore, the energy consumption of the reaction can be greatly reduced, and the process cost of chemical reaction is reduced. In addition, the pumping capacity of a material pump ranges from 1.4 t/h to 3.5 t/h. The optimal reaction temperature depends on wood species and the reactor scale, different wood species have slight temperature window differences due to different chemical components, and the larger the reactor scale is, the higher the reaction temperature is, so that the reduction in heat transfer and mass transfer is compensated. Generally, the higher the reaction temperature is, the higher the reaction rate is, but cellulose will be gradually hydrolyzed at 150° C. Because the mechanical property of the cellulose is relatively high, and it is preferably reserved as much as possible, the reaction temperature is preferably set to be below 150° C. In some embodiments, the temperature of chemical modification in the closed high-pressure system, namely the target temperature, is specifically 125° C., 116° C., or 130° C. In some embodiments, the target time of chemical modification in the closed high-pressure system is specifically 6 hours, 8 hours, or 6.5 hours. When chemical modification is performed in the closed high-pressure system, the target pressure of chemical modification preferably ranges from 0.07 MPa to 1.9 MPa. The temperature rise rate in chemical modification is not specially limited in the present disclosure, and the temperature rise rate in chemical modification performed under normal pressure or in the closed high-pressure system can specifically ranges from 0.2° C./min to 5° C./min, more preferably ranges from 0.5° C./min to 5° C./min. In some embodiments, the temperature rise rate can be specifically 3° C./min, 2.5° C./min, 5° C./min, 2° C./min, 0.5° C./min or 0.2° C./min. When the temperature of the system reaches and is stabilized at the target temperature, the reaction in the closed high-pressure system is preferably maintained at the target temperature for 1 hour to 12 hours or maintain at the target temperature for 24 hours to 72 hours under normal pressure, and then cooling is started. Because the modified unidirectional veneer will recombine intermolecular hydrogen bonds in the cooling process and start crystallization at the same time, the cooling method may have a significant influence on the final performance. If the cooling rate is too high, the molecular chain of the unidirectional veneer with partial substances removed will be fixed too early. Consequently, the intermolecular acting force is not completely established, resulting in low crystallinity and large crystalline particles, which all have negative effects on the performance. Therefore, in the present disclosure, after chemical modification is finished, the reaction liquid preferably exchanges heat with the external environment at room temperature to slowly cool the reaction liquid. This cooling mode can promote the establishment of intermolecular acting force so as to obtain crystals with high crystallinity and large grain size. Specifically, this mode includes water cooling or air cooling, and specifically, this cooling mode includes indirect water cooling, air cooling, or direct water cooling. The cooling rate preferably ranges from 0.2° C./min to 10° C./min, more preferably ranges from 1° C./min to 10° C./min; and in some embodiments, the cooling rate is specifically 0.2° C./min, 1° C./min, 0.5° C./min, 2° C./min, or 3° C./min.

After the temperature is decreased to reach operation temperature (such as 60° C.), the unidirectional veneer with partial substances removed is preferably washed and dried. Specifically, the reactor is opened to take out the unidirectional veneer with partial substances removed, or the material frame loaded with the unidirectional veneer with partial substances removed is taken out. The obtained materials are put into water for washing wholly, or the material frame loaded with the materials is put into water for washing wholly. The washing is to remove chemical substances remaining on the surface, and meanwhile, sodium cellulose which is possibly generated in the reaction process can react back to cellulose, so that pure natural chemical components can be kept in the wood. The washing processes can be carried out for a plurality of times according to the condition of the materials. After being washed, the materials are dried to obtain the unidirectional veneer with partial substances removed; the materials can be dried naturally or can be put into a drying oven to be dried in an accelerated manner. Compared with the unidirectional veneer, the mass of the unidirectional veneer with partial substances removed is reduced by 10% to 60%, further reduced by 35% to 55%. In some embodiments, compared with the unidirectional veneer, the mass of the unidirectional veneer with partial substances removed is specifically reduced by 50%, 42%, 46.8%, 49.1%, 49%, or 48.2%.

In the chemical modification process, the mass of unidirectional veneer is reduced by 10% to 60%, thus a large number of cavities will be generated in the microstructure, and the unidirectional veneer with partial substances removed will have good plastic deformation capacity due to these cavities and can be easily compressed to be smaller under an external force. Moreover, the reduction of mass is caused by that a large amount of lignin and hemicellulose in the unidirectional veneer are removed, and the proportion of cellulose is increased in the aspect of overall components. Because the cellulose in the three main components of the unidirectional veneer has the best mechanical property, the material has the potential enhancement possibility by proportion adjustment. The plastic deformation capacity of wood without being modified is poor, and if the wood without being modified is subjected to remarkable plastic deformation, it is generally required to carry out water vapor heating and humidifying treatment for 2 hours to 24 hours to achieve sufficient softening effect. The shrinkage and densification process is a key process. It means that if the material needs to meet the requirement for achieving the volume compression effect within a short time, the material may need to have very good plastic deformation capacity, which is not achieved by the wood without being modified. Moreover, if the material subjected to chemical treatment needs to be kept complete and flat, it is needed to control the reaction degree in the chemical reaction process. If the reaction is excessive, a large number of wrinkles will be generated on the veneer, consequently, levelling cannot be achieved; and if the reaction is insufficient, the compression degree of the unidirectional veneer will be low, and consequently, the mechanical property of the densified material is poor.

In the present disclosure, the removal ratio of lignin ranges from 20% to 80% and the removal ratio of hemicellulose ranges from 30% to 80% after unidirectional veneer is chemically modified. Specifically, the removal ratio of the hemicellulose and the lignin is approximately in a positive correlation with the temperature and time within the temperature and time range of chemical modification provided by the present disclosure.

Referring back to FIG. 3, the unidirectional veneer with partial substances removed 330 is subjected to shrinkage treatment in the at least one direction 340. The shrinkage treatment includes transverse shrinkage and thickness shrinkage according to force decomposition. The transverse shrinkage and the thickness shrinkage mean that shrinkage will occur in both the transverse direction and thickness direction which are vertical to the fiber direction of the unidirectional wood fiber paper to achieve a densification effect. The number of times of the shrinkage treatment can be selected according to the direction of force, as long as the transverse (horizontal direction) shrinkage and the vertical (thickness direction) shrinkage can be actually realized according to the force decomposition.

In some embodiments, the shrinkage treatment includes the transverse shrinkage treatment and the thickness shrinkage treatment, namely bidirectional shrinkage treatment. The force of the transverse shrinkage treatment is intersected with the force of the thickness shrinkage treatment. The bidirectional shrinkage of the wood fiber paper can be realized by different devices respectively, and the shrinkage in the two directions can also be simultaneously or alternately realized in one device.

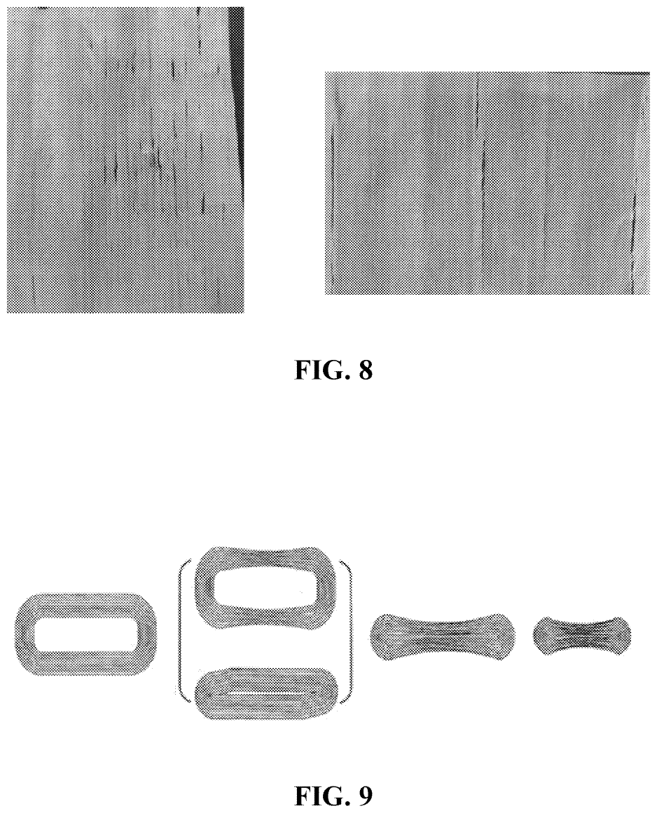

When the thickness of the processed feedstock unidirectional veneer is below 0.8 mm, transverse shrinkage is necessary. In a small thickness range, the arrangement density of the cellulose and the distribution of the lignin and the hemicellulose in the transverse direction of any position of the unidirectional veneer are not uniform, and the distribution of reaction media in chemical or biological treatment is relatively more uniform. If the cellulose in a certain area in the transverse direction is less, the lignin and the hemicellulose will be removed more, more connecting substances are inevitably lost in partial the area by chemical modification, and the cellulose structure of the area is in a falling apart state. The unidirectional shrinkage is carried out in the thickness direction, cracks are easily generated in the area due to the lack of necessary transverse connecting force. FIG. 8 is an object diagram of cracks generated by unidirectional shrinkage in a thickness direction, according to some embodiments of the present disclosure.

According to the present disclosure, the transverse shrinkage treatment preferably includes applying an external mechanical force and/or performing dehydration spontaneous shrinkage in the transverse direction. The external mechanical force applied in the transverse direction is in a direction intersected with the extending direction of wood fibers and/or fiber bundles of the unidirectional veneer with partial substances removed in the plane.

The method for applying the external mechanical force in the transverse direction is a method well known to those skilled in the art, there is no special limitation. Methods with parameters such as pressure meeting the process requirements are all available. For example, a film material that can perform transverse shrinkage is used and attached to the surface of unidirectional veneer with partial substances removed, and after pressure is applied, the film material is removed. When controlling the film material to perform transverse shrinkage, the friction force between the film and the surface of the unidirectional veneer with partial substances removed will lead to the transverse shrinkage of the unidirectional veneer with partial substances removed. In this process, the tension of the film material influences the transverse shrinkage degree, specifically, the tension of the film material is preferably controlled to achieve the equivalent transverse shrinkage pressure of 0.001 MPa to 1.5 MPa, more preferably 0.01 MPa to 1.5 MPa. Optionally, the tension of the film material is controlled to achieve equivalent transverse shrinkage pressure of 0.001 MPa, 0.002 MPa, 0.005 MPa, 0.01 MPa, 0.05 MPa, 0.08 MPa, 0.1 MPa, 0.2 MPa, 0.5 MPa, 0.8 MPa, 1.0 MPa, 1.2 MPa, 1.4 MPa, 1.5 MPa, or a range between any two of the above values. Moreover, the friction force on the surface, away from the film material, of the unidirectional veneer with partial substances removed may also influence the transverse shrinkage of the unidirectional veneer with partial substances removed, and therefore the lower the roughness of the contact side of the surface, away from the film material, of the unidirectional veneer with partial substances removed is, the better the effect is. Specifically, it preferably makes contact with the surface having roughness smaller than or equal to Ra6.3, and optionally, the roughness of the contact side is Ra0.0063, Ra0.025, Ra0.05, Ra0.1, Ra0.2, Ra0.4, Ra0.8, Ra1.6, Ra3.2, or Ra6.3. In addition, the external mechanical force can also be achieved by mechanical force, such as roller rubbing, and direct pressure applying methods. The pressure of applying the external mechanical force in the transverse direction preferably ranges from 0.001 MPa to 1.5 MPa, more preferably ranges from 0.01 MPa to 1.5 MPa; and optionally, the pressure of applying the external mechanical force in the transverse direction is 0.001 MPa, 0.002 MPa, 0.005 MPa, 0.01 MPa, 0.05 MPa, 0.08 MPa, 0.1 MPa, 0.2 MPa, 0.5 MPa, 0.8 MPa, 1.0 MPa, 1.2 MPa, 1.4 MPa, 1.5 MPa, or a range between any two of the above values.

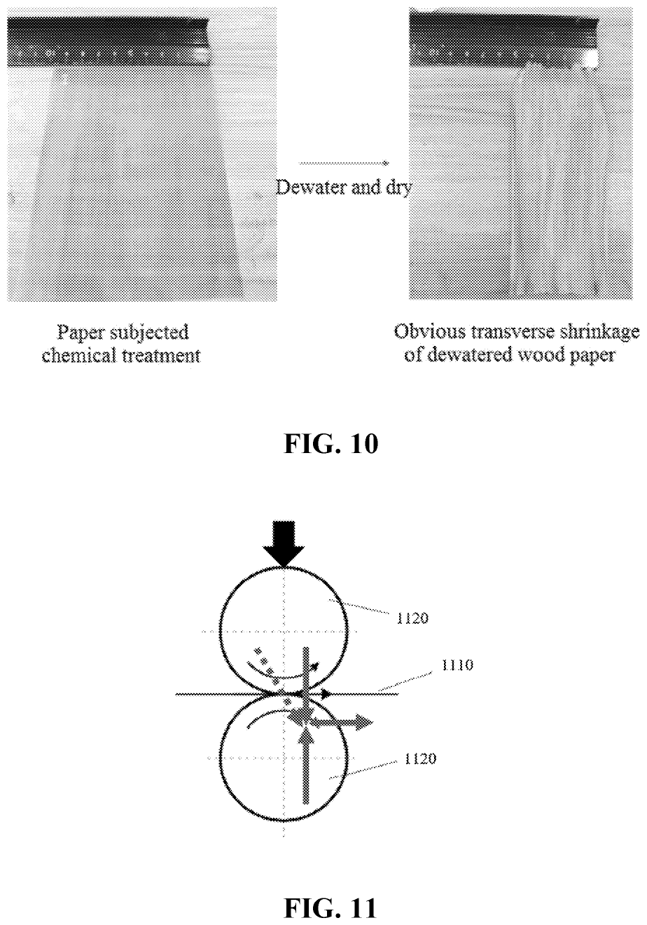

The transverse shrinkage can be implemented by spontaneous acting force in the unidirectional veneer with partial substances removed, namely dehydration and spontaneous shrinkage; thin wood fiber paper will be subjected to spontaneous transverse shrinkage during dehumidification. FIG. 9 is a schematic diagram of sinking and shrinkage of a tube cavity of wood fiber paper pipe in spontaneous transverse shrinkage, according to some embodiments of the present disclosure. Its principle is that partial lignin and hemicellulose which support the tube cavity in the chemically treated veneer with partial substances removed are removed, a large number of cavities are contained in the microstructure, and the cavities can be easily filled with water. In addition, because cellulose in the continuous veneer plays a role of a main component, and there are a large number of hydroxyl groups in the chemical structure of cellulose, and it is a hydrophilic material, water molecules are promoted to enter the cavities of the microstructure. During dehydration, water is removed from the cavities, the cavities will disappear due to capillary force, thus the distance between cellulose microfibers is rapidly reduced, and hydrogen bonds between the microfibers are reestablished; and the spontaneous transverse shrinkage effect is achieved by shrinkage of the structure and establishment of chemical bonds. Macroscopically, wrinkles are generated on the wood fiber paper, so the width in the transverse direction is reduced, and the compactness is increased. FIG. 10 is an object diagram of a unidirectional wood fiber paper in spontaneous transverse shrinkage, according to some embodiments of the present disclosure.

In the present disclosure, the transverse shrinkage can be carried out under a normal temperature condition or a high temperature condition; specifically, the temperature of transverse shrinkage treatment preferably ranges from 15° C. to 150° C., more preferably ranges from 25° C. to 130° C.; optionally, the temperature of the transverse shrinkage treatment is 20° C., 25° C., 30° C., 50° C., 70° C., 80° C., 90° C., 100° C., 110° C., 120° C., 130° C., or a range between any two of the above values. The time of the transverse shrinkage treatment preferably ranges from 1 second to 4 minutes; optionally, the time of the transverse shrinkage treatment is 1 second, 10 seconds, 30 seconds, 1 minute, 2 minutes, 3 minutes, 4 minutes, or a range between any two of the above values. The shrinkage percentage of a unidirectional veneer feedstock subjected to the transverse shrinkage treatment preferably ranges from 2% to 40%; and optionally, the shrinkage percentage of the transverse shrinkage treatment is 2%, 5%, 10%, 15%, 20%, 25%, 30%, 35%, 40%, or a range between any two of the above values.

In some embodiments, the transverse shrinkage treatment is specifically spontaneous transverse shrinkage, specifically, the unidirectional veneer with partial substances removed in a wet state is dried to spontaneously achieve the spontaneous transverse shrinkage effect, and after one-time or multi-time spontaneous transverse shrinkage, and the unidirectional veneer with partial substances removed is filled with water again, the transverse shrinkage in the direction vertical to the fiber direction is obvious, so that the transverse tensile property is improved.

A normal wood slab can be softened with steam and then subjected to hot-pressing compression densification, but in the densification process, it is needed to apply a large pressure to the wood slab for a long time. The unidirectional veneer in the present disclosure is thin, and is prone to cracking when being directly subjected to hot pressing, so the obtained densification effect is limited. After the veneer is chemically modified, its mass will be decreased by 35% to 55%, and a large number of cavities are formed inside. Because the removed chemical component is hydrophobic lignin, the hydrophilicity of the modified unidirectional veneer with partial substances removed is remarkably improved, the internal cavities can be rapidly filled with water molecules, thus the overall structure is soft, and densification is easily conducted through natural water loss. Moreover, the energy consumption in the densification process is low, the time is short, and batch production is facilitated.

In the process of spontaneous transverse shrinkage, external mechanical force is not needed at all, the modified unidirectional veneer with partial substances removed can realize the effect of spontaneous transverse shrinkage through the microstructure water filling-dewatering process, and this process is also called as wood keratinization. Its principle is that there are a large number of cavities in the microstructure of the chemically modified wood, and these cavities are easily filled with water. In addition, because cellulose in continuous veneer play a role of a main component, there are a large number of hydroxyl groups in the chemical structure of cellulose, and it is a hydrophilic material, water molecules are promoted to enter the cavities of the microstructure. In the water filling process, the cavities between cellulose microfibrils are obviously expanded. In the subsequent drying process, water will be removed from the cavities, the cavities will disappear due to capillary force, the distance between the cellulose microfibrils will be rapidly reduced, hydrogen bonds between the microfibrils will be reestablished, the effect of spontaneous transverse shrinkage, especially transverse shrinkage of the veneer vertical to the fiber in the axial direction, is achieved through shrinkage of the structure and establishment of chemical bonds, and the densification effect is more obvious.

According to the present disclosure, in the spontaneous transverse shrinkage process, the densification effect can be achieved completely by chemical and physical changes spontaneously generated by the modified unidirectional veneer with partial substances removed in the drying process without using any external pressure device. Specifically, the spontaneous transverse shrinkage is to dry the unidirectional veneer with partial substances removed in the wet state, that is, the spontaneous transverse shrinkage includes water filling treatment and dehydration treatment, the water filling treatment is to make the unidirectional veneer with partial substances removed in the wet state; the water filling treatment is to preferably make the water content reach 60 wt % to 120 wt %; optionally, the water filling treatment makes the water content reach 60 wt %, 80 wt %, 100 wt %, 120 wt % or a range between any two of the above values. The dehydration treatment includes natural drying and/or heating drying. When the dehydration treatment is performed in the natural drying way in the environment, the environmental humidity in the natural drying is preferably less than 50% RH, otherwise, a large amount of water is still reserved in the structure of the unidirectional veneer with partial substances removed after drying. If the dehydration treatment is performed in the heating drying way, the time of the dehydration treatment can be reduced, the process time is decreased, and the unidirectional veneer with partial substances removed can be dried to reach the water content below 10 wt % to the maximum extent, so that the densification effect is improved; the dehydration treatment preferably makes the water content reach a range of 2 wt % to 20 wt %; and optionally, the dehydration treatment makes the water content reach 2 wt %, 5 wt %, 10 wt %, 15 wt %, 20 wt %, or a range between any two of the above values. In the present disclosure, there is no special requirement on the drying temperature and drying time in the spontaneous transverse shrinkage process, as long as the target water content is achieved finally. The process of spontaneous transverse shrinkage can be performed once, or repeated for 2 to 10 times, preferably 2 to 6 times. The process of repeated spontaneous transverse shrinkage is that after one time of spontaneous transverse shrinkage is finished, the unidirectional veneer with partial substances removed is refilled with water, and then the same spontaneous transverse shrinkage process is performed. The repeated spontaneous transverse shrinkage can make the material have a better densification effect because the spontaneous transverse shrinkage process is uncontrollable, intermolecular force in the unidirectional veneer structure with partial substances removed cannot be established perfectly after one time of spontaneous transverse shrinkage is finished. After one or more times of spontaneous transverse shrinkage, the unidirectional veneer with partial substances removed is refilled with water, the unidirectional veneer with partial substances removed vertical to the fiber direction will have certain shrinkage in the transverse width, and the transverse fiber bonding force is improved, which indicates that partial irreversible transverse shrinkage densification effect is realized.

According to the present disclosure, the thickness shrinkage treatment includes applying a mechanical pressure in the thickness direction, and the specific method is a method for applying an external mechanical pressure in the thickness direction of the chemically treated veneer to cause the shrinkage of the veneer in the thickness direction. Moreover, methods with pressure and other parameters meeting the process requirements are basically available, and the used devices include but not limited to a flat press, a plastic vacuum forming machine, a hot press roll, a cold press roll, a continuous flat press, a continuous belt press, and the like. By applying the external mechanical pressure, the flatness of the veneer is improved. Moreover, the thickness is reduced under the action of force, excessive water is extruded out, and thereby obtaining the flat and dense unidirectional wood fiber paper with the water content less than 30%. Moreover, the thickness shrinkage is performed on a single or stacked veneers; that is, the thickness shrinkage treatment can be performed on a single veneer or a plurality of stacked veneers, and the process efficiency is higher when the thickness shrinkage is performed on the plurality of stacked veneers. Due to the influence of the process, the number of the stacked veneers ranges from 2 veneers/pile to 30 veneers/pile, more preferably ranges from 3 veneers/pile to 20 veneers/pile. The pressure of thickness shrinkage treatment preferably ranges from 0.01 MPa to 80 MPa, more preferably ranges from 0.1 MPa to 60 MPa, and still more preferably ranges from 3 MPa to 10 MPa; optionally, the pressure of the thickness shrinkage treatment is 1 MPa, 2 MPa, 3 MPa, 4 MPa, 5 MPa, 6 MPa, 8 MPa, 10 MPa, 12 MPa, 15 MPa, 20 MPa, 25 MPa, 30 MPa, 35 MPa, 40 MPa, 45 MPa, 50 MPa, 55 MPa, 60 MPa, or a range between any two of the above values. According to a pressure and area calculation formula, under a condition that the required pressure is fixed, the more the number of the piles of the unidirectional veneer with partial substances removed is, the higher the gauge pressure of the flat press is. If the flat press is used, the unidirectional veneer with partial substances removed is easily broken due to instant high pressure is to be taken into consideration, it is needed to slowly increase the pressure to reach the target pressure. The thickness shrinkage treatment can be carried out at normal temperature or high temperature, and the specific process temperature preferably ranges from 15° C. to 150° C., and more preferably ranges from 25° C. to 130° C.; optionally, the temperature of the thickness shrinkage treatment is 15° C., 25° C., 35° C., 50° C., 80° C., 100° C., 120° C., 130° C., 150° C., or a range between any two of the above values. In order to reduce the process cost, the time of the thickness shrinkage treatment (only achieving the densification effect) preferably ranges from 0.1 min to 3 min; and optionally, the time of the thickness shrinkage treatment is 0.1 min, 0.5 min, 1 min, 2 min, 3 min, or a range between any two of the above values. The process time will be decreased at high temperature, but the device cost will also be increased.

In some embodiments, the thickness shrinkage treatment is carried out by rolling. Specifically, a pair of hot rolls which rotate oppositely is adopted for continuous hot pressing. FIG. 11 is a schematic diagram of continuous hot pressing processing of a hot roll, according to some embodiments of the present disclosure. As shown in FIG. 11, a pair of hot rolls 1120 which rotate oppositely is adopted for continuous hot pressing the unidirectional veneer with partial substances removed 1110. The stress direction of the unidirectional wood fiber paper is not determined during rolling, but it is a transverse direction or a thickness direction according to force decomposition.

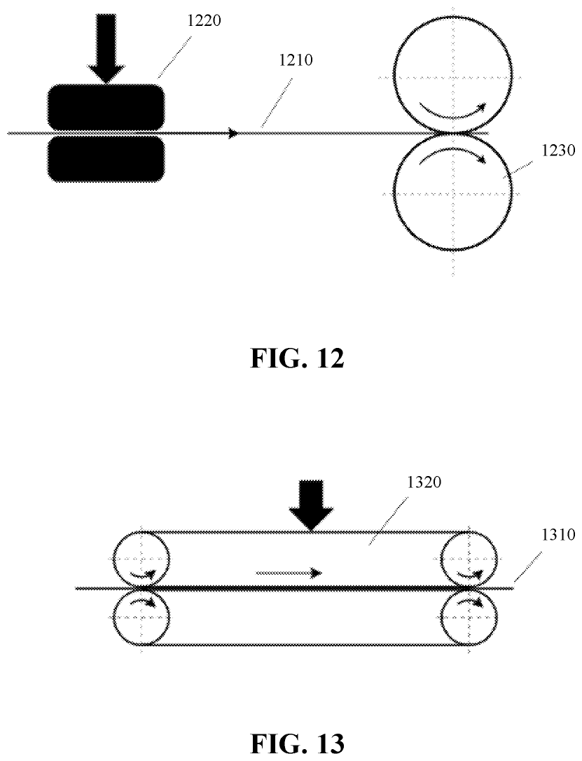

In some embodiments, the thickness shrinkage treatment is carried out by continuous hot pressing through the continuous flat press, as shown in FIG. 12, FIG. 12 is a schematic diagram of continuous hot pressing processing of a continuous flat press, according to some embodiments of the present disclosure. As shown in FIG. 12, the unidirectional veneer with partial substances removed 1210 is subjected to continuous hot pressing through the continuous flat press 1220 and a driving roll 1230.

In some embodiments, the thickness shrinkage treatment is carried out by continuous hot pressing through the belt press, as shown in FIG. 13, FIG. 13 is a schematic diagram of continuous hot pressing processing of a belt press, according to some embodiments of the present disclosure. As shown in FIG. 13, the unidirectional veneer with partial substances removed 1310 is subjected to hot pressing through the belt press 1320.

In the present disclosure, the process time and the number of the process for the transverse shrinkage treatment and the thickness shrinkage treatment may be different according to the different processes used for the transverse shrinkage treatment and the thickness shrinkage treatment. The transverse shrinkage treatment and the thickness shrinkage treatment can be carried out for multiple times, or for one time, can be alternately or simultaneously carried out, and finally, the running time and the running times of the target parameter design process are achieved.

The effect of bidirectional shrinkage treatment is mainly reflected in the reduction of the water content and the thickness of the unidirectional veneer with partial substances removed, and after the unidirectional veneer with partial substances removed is subjected to bidirectional shrinkage treatment, the thickness of the veneer feedstock is reduced to be less than or equal to 0.6 mm from the original thickness of 0.05 mm to 0.8 mm. The thickness of the veneer subjected to bidirectional shrinkage treatment is preferably 10% to 80% of the thickness of the unidirectional veneer. The water content of the veneer cleaned and soaked after chemical modification is preferably reduced to be less than 30% after bidirectional shrinkage treatment, and more preferably reduced to be 20% to 30%.

In the present disclosure, the unidirectional wood fiber paper is dense in the thickness direction and the transverse (width) direction through the external or spontaneous physical effect by the bidirectional shrinkage process. By transverse shrinkage, the transverse binding force and the compactness of the unidirectional wood fiber paper can be increased, and transverse cracking of the unidirectional wood fiber paper is avoided. By thickness shrinkage, the compactness of the unidirectional wood fiber paper can be increased, and the performance of the unidirectional wood fiber paper is improved. Through the simultaneous or sequential shrinkage effect in the two directions, the performance of the unidirectional wood fiber paper can be greatly improved. Further, in cooperation with temperature control, rapid shrinkage and densification and rapid dehydration of the unidirectional wood fiber paper can be achieved at the same time, and wrinkles and transverse cracks are avoided. The bidirectional shrinkage process provided by the present disclosure can be generally completed within 5 min, so the process efficiency is high.

In some embodiments, the thickness shrinkage includes hot-pressing treatment under a negative pressure condition; the thickness shrinkage as well as the levelling and dehydration of the unidirectional wood fiber paper can be simultaneously implemented by the hot-pressing treatment under the negative pressure condition. The pressure of the hot-pressing treatment preferably ranges from 0.1 MPa to 60 MPa, more preferably ranges from 0.1 MPa to 15 MPa; optionally, the pressure of the hot-pressing treatment is 0.01 MPa, 0.05 MPa, 0.1 MPa, 0.5 MPa, 1 MPa, 5 MPa, 10 MPa, 15 MPa, 20 MPa, 25 MPa, 30 MPa, 35 MPa, 40 MPa, 45 MPa, 50 MPa, 55 MPa, 60 MPa, or a range between any two of the above values. The flow in the negative pressure condition preferably ranges from 50 L/min to 500 L/min; optionally, the flow in the negative pressure condition is 50 L/min, 80 L/min, 100 L/min, 150 L/min, 200 L/min, 250 L/min, 300 L/min, or a range between any two of the above values. The temperature of the hot-pressing treatment preferably ranges from 50° C. to 150° C.; optionally, the temperature of the hot-pressing treatment is 50° C., 80° C., 100° C., 120° C., 130° C., 150° C., or a range between any two of the above values. The time of the hot-pressing treatment preferably ranges from 0.5 min to 20 min; and optionally, the time of the hot-pressing treatment is 0.5 min, 1 min, 2 min, 3 min, 4 min, 5 min, 8 min, 10 min, 12 min, 15 min, 18 min, 20 min, or a range between any two of the above values. If the thickness shrinkage treatment is realized only by the hot-pressing treatment under the negative pressure condition, the pressure is low, consequently, more time is needed.

In the present disclosure, according to requirement for the size of the unidirectional wood fiber paper, splicing is carried out before or after bidirectional shrinkage treatment. Referring back to FIG. 3, the flatness of the wood fiber paper 350 subjected to bidirectional shrinkage treatment 340 is improved, and the water content is reduced. However, due to the size limitation of the veneer feedstock, the veneer in chemical treatment is discontinuous, and in order to meet the use requirement, it is needed to connect the wood fiber paper to achieve different sizes. During use, the wood fiber paper can be cut according to actual requirements, then used for preparing products of different sizes. For the whole size, the wood fiber paper can be spliced to be infinite in width and length theoretically, the length of the unidirectional wood fiber paper in splicing preferably ranges from 0.1 m to 5 m, and the width preferably ranges from 0.01 m to 1 m. In the present disclosure, the splicing can be performed on two or a plurality of pieces of unidirectional wood fiber paper, as long as the size of the spliced wood fiber paper meets the requirement; the splicing is specifically to mark splicing contours on the unidirectional veneer with partial substances removed or the wood fiber paper subjected to bidirectional shrinkage treatment, and then splice the corresponding parts. More specifically, before splicing, splicing parts are designed on the unidirectional veneers with partial substances removed and to be spliced or the wood fiber paper subjected to shrinkage treatment and to be spliced, it is mainly to mark related splicing contours, then some splicing technologies are applied to connect the plurality of pieces of scattered unidirectional veneers with partial substances removed or the wood fiber paper subjected to shrinkage treatment to form a piece of large-size unidirectional wood fiber paper. After splicing, the thickness of the wood fiber paper at the spliced position is about in a range of 0.08 mm to 0.12 mm.

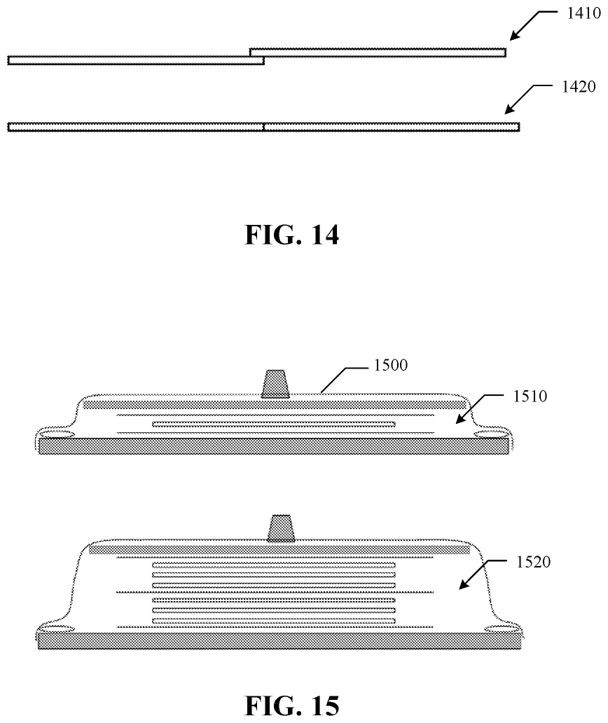

In the present disclosure, the unidirectional wood fiber paper can be spliced in a partial region stacking manner, as shown in 1410 in FIG. 14, it can also be spliced in a region-free stacking manner, as shown in 1420 in FIG. 14.

In the present disclosure, the splicing process can be one or more selected from: glue splicing, glue line seam splicing, wet pressing splicing, and film-lamination splicing.

In some embodiments, the glue splicing can be adopted. Specifically, the glue is coated on an stacking partial one unidirectional veneer with partial substances removed and to be spliced or one piece of wood fiber paper subjected to shrinkage treatment and to be spliced, and then the stacking parts of the other unidirectional veneer with partial substances removed or the other piece of wood fiber paper subjected to shrinkage treatment are pressed on the stacking part coated with the glue, thus the stacking parts of two unidirectional veneers with partial substances removed or two pieces of wood fiber paper subjected to shrinkage treatment are spliced after the glue is cured, and the size of the continuous wood fiber paper is increased. Because the stacking parts are the thicknesses of the two unidirectional veneer with partial substances removed or the two pieces of wood fiber paper subjected to shrinkage treatment, and are thicker than other parts; and pressure can be applied to the stacking parts, so as to reduce the thicknesses of the stacking parts, and improve the thickness uniformity of the whole wood fiber paper.

In some embodiments, the glue line seam splicing can be adopted. Specifically, the contour shapes of the unidirectional veneer with partial substances removed and to be spliced or the wood fiber paper subjected to shrinkage treatment and to be spliced are designed to be completely fitted with each other, the contours of two unidirectional veneers with partial substances removed and to be spliced or two pieces of wood fiber paper subjected to shrinkage treatment and to be spliced are fitted with each other, and then glue lines move back and forth along two fitted contour lines. The glue lines are stuck with the surface of the unidirectional wood fiber paper, the glue lines are continuous so that the positions of the two unidirectional veneers with partial substances removed or the two pieces of wood fiber paper subjected to shrinkage treatment are fixed, and thus the purpose of splicing the unidirectional wood fiber paper is realized. In order to improve the firmness of splicing, on one hand, the number of the glue lines on the two unidirectional veneers with partial substances removed or the two pieces of wood fiber paper subjected to shrinkage treatment can be increased in the seam splicing process; on the other hand, both sides of the unidirectional veneer with partial substances removed or the wood fiber paper subjected to shrinkage treatment can be subjected to seam splicing. The glue line seam splicing has the advantages that there are no stacking parts of two pieces of unidirectional wood fiber paper in the seam splicing process, and the size of the wood fiber paper can be increased only by fitting the contours, so that the thickness of the seam splicing partial the wood fiber paper is basically the same as that of other parts.

In some embodiments, the wet pressing splicing can be adopted. Specifically, the wet pressing splicing mode is similar to the glue splicing mode, but glue is not suitable, and only water is used. Water is applied to the stacking parts of the unidirectional veneer with partial substances removed and to be spliced or the wood fiber paper subjected to shrinkage treatment and to be spliced until the stacking parts are wetted thoroughly and then overlapped together, a large pressure (≥5 MPa) is applied, and heating and drying are carried out till the wood fiber paper is dried and then attached together, thus achieving the purpose of splicing. The unidirectional veneer with partial substances removed or the wood fiber paper subjected shrinkage treatment in the wet state is soft in structure. Under the action of large pressure, the structures of two unidirectional veneers with partial substances removed or two pieces of wood fiber paper subjected to shrinkage treatment can be tightly pressed together and bonded to each other till hydrogen bond are bonded, the pressure is kept till the wood fiber paper is dried, and therefore the bonding force is fixed, and splicing is finished. The wet pressing splicing mode has the advantages that the pure natural attribute of the wood fiber paper is well kept, wood fiber paper of any size and breadth can be easily manufactured, and after film-lamination/pre-impregnating is conducted in the later procedure, a continuous prepreg (e.g., unidirectional wood fiber paper prepreg 360 shown in FIG. 3) of infinite sizes can be produced theoretically.

In some embodiments, the film-lamination splicing can be adopted. Specifically, a continuous glue film is selected according to the needed large size, then pieces of small-size unidirectional wood fiber paper are pressed on the glue film, and all the pieces of small-size unidirectional wood fiber paper are spliced together through the connection of the glue film, thus achieving the purpose of increasing the size. The type of the glue film can be selected according to needs, the mode that a thin mat is mixed with glue can also be selected for self-manufacturing, and its principle is that a layer of film is added to connect the pieces of small-size unidirectional wood fiber paper, and the continuous prepreg of infinite sizes can also be produced theoretically by this method.

The present disclosure also provides another preparation method for unidirectional wood fiber paper, which includes the following steps: A1) chemically modifying a unidirectional veneer to obtain a unidirectional veneer with partial substances removed; and A2) performing shrinkage treatment and levelling treatment on the unidirectional veneer with partial substances removed in at least one direction to obtain the unidirectional wood fiber paper; and the levelling treatment includes performing planar hot pressing in a negative pressure air pumping environment.

The shrinkage treatment in step A1) and step A2) is the same as the above, which will not be listed herein. Specifically, the thickness shrinkage treatment in the shrinkage treatment in step A2) does not include the hot-pressing treatment under the negative pressure condition.

Through the levelling treatment, the veneer subjected to shrinkage treatment can be dehydrated more efficiently and quickly, and good flatness can be achieved in the dehydration process, and then the unidirectional wood fiber paper can be obtained. The levelling effect is mainly reflected in quickly and efficiently improving the flatness of the wood fiber paper and reducing the water content, and then dry and flat unidirectional wood fiber paper is obtained.

According to the present disclosure, further, specifically, the water content of the obtained unidirectional wood fiber paper can be less than or equal to 10 wt % by the levelling treatment.

According to the present disclosure, exhaust channels are arranged on two contact surfaces or a single contact surface of the unidirectional wood fiber paper during levelling treatment. Specifically, it can be realized by various forms of devices such as a heatable negative pressure film press, a blister forming leveling machine, and/or a vacuum hot press. For example, the vacuum hot press provided with a plurality of exhaust channels. FIG. 15 illustrates a schematic diagram of levelling by plastic forming, according to some embodiments of the present disclosure. As shown in FIG. 15, a blister forming leveling machine 1500 is used for leveling treatment. In some embodiments, a single sheet of unidirectional wood fiber paper 1510 is subjected to a leveling treatment. In some embodiments, a plurality of sheets of unidirectional wood fiber paper 1520 are subjected to a leveling treatment. The levelling process is characterized in that heating can be performed in the processing process, and double surfaces or the single surface of the pressed wood fiber paper can be directly provided with the exhaust channels, so that water vapor can be discharged. Generally, the pressure in the levelling process will be obviously lower than the pressure in thickness shrinkage, and the pressure is too high, so the discharge speed of the water vapor will be reduced, and the levelling efficiency will be reduced. When the levelling process is adopted, the pressure is selected to meet the purpose of preventing the unidirectional wood fiber paper from wrinkles in the drying process. The pressure in the levelling treatment can range from 0.01 MPa to 2 MPa; optionally, the pressure of the levelling treatment is 0.01 MPa, 0.05 MPa, 0.1 MPa, 0.5 MPa, 1 MPa, 1.5 MPa, 2 MPa, or a range between any two of the above values. The heating temperature of the levelling treatment ranges from 40° C. to 150° C.; and optionally, the heating temperature of the levelling treatment is 40° C., 50° C., 70° C., 80° C., 100° C., 120° C., 150° C., or a range between any two of the above values. By reasonably arranging the exhaust channels on the contact surfaces of the unidirectional wood fiber paper, the levelling can be finished within 0.1 min to 4 min; and optionally, the time of the levelling treatment is 0.1 min, 0.5 min, 1 min, 2 min, 3 min, 4 min, or a range between any two of the above values.

The present disclosure also provides a wood fiber paper prepreg, which includes the unidirectional wood fiber paper and a polymer layer attached to at least one surface of the unidirectional wood fiber paper.

According to the present disclosure, a polymer in the polymer layer is thermosetting resin and/or thermoplastic resin well known to those skilled in the art, there is no special limitation. In the present disclosure, specifically, the thermosetting resin can be one or more selected from epoxy resin, unsaturated polyester, polybutadiene resin, phenolic resin, and crosslinkable polyurethane; and specifically, the thermoplastic resin can be selected from polyamide, polylactic acid, polyurethane, ethylene-vinyl acetate copolymer, ethylene-acrylate copolymer, copolyester and other hot melt adhesive-grade polymers.

According to the present disclosure, the mass of the polymer layer preferably ranges from 5% to 85% of the mass of the unidirectional wood fiber paper prepreg.

According to the present disclosure, the unidirectional wood fiber paper prepreg includes the unidirectional wood fiber paper; and the single surface and/or two surfaces of the unidirectional wood fiber paper are provided with the polymer layer.

According to the present disclosure, the thickness ratio of the polymer layer to the unidirectional wood fiber paper preferably ranges from (5:1) to (0.05:1).

According to the present disclosure, the areal density of the unidirectional wood fiber paper prepreg preferably ranges from 30 g/m² to 500 g/m².

According to the present disclosure, the thickness of the unidirectional wood fiber paper prepreg preferably ranges from 0.03 mm to 0.7 mm.

According to the present disclosure, the gram weight of the polymer layer preferably ranges from 5 g/m² to 200 g/m².

The present disclosure also provides a preparation method for a unidirectional wood fiber paper prepreg, which includes the following step: transferring a polymer to at least one surface of the unidirectional wood fiber paper to obtain the unidirectional wood fiber paper prepreg; and the transfer method is one or more selected from film-lamination, infiltration, and coating.

In some embodiments, the transfer method is film-lamination, and specifically includes the following steps: enabling the unidirectional wood fiber paper and a polymer adhering film to pass an automatic film-lamination machine that has a double-side heating function, in which, the polymer that is in a molten state at a high temperature and the unidirectional wood fiber paper can be mutually infiltrated under the rolling action, thereby obtaining a single-layer flaky unidirectional wood fiber paper prepreg with the polymer layer on the surface.

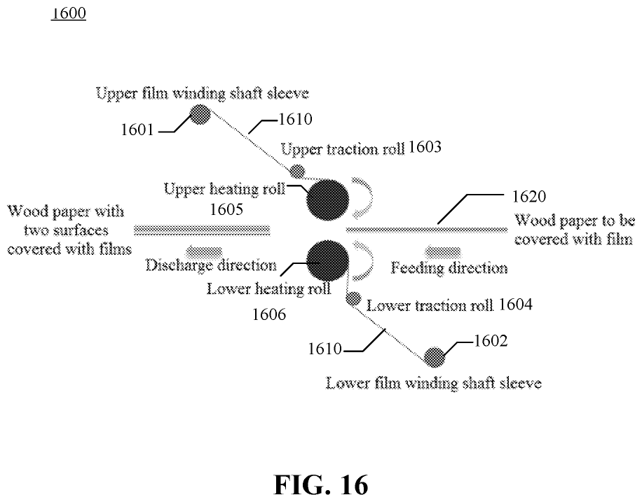

FIG. 16 is a preparation process of a unidirectional wood fiber paper prepreg, according to some embodiments of the present disclosure. As shown in FIG. 16, the preparation process 1600 includes the following steps: preparing two polymer adhering film reels that have the same breadth as the unidirectional wood fiber paper, and respectively fixing to an upper film winding shaft sleeve 1601 and a lower film winding shaft sleeve 1602 of the automatic film-lamination machine; opening a paper feeding table plate and a heating rubber roll protective cover, enabling the tail ends of polymer adhering films 1610 on the upper film winding shaft sleeve 1601 and the lower film winding shaft sleeve 1602 to respectively pass through an upper traction roller 1603 and a lower traction roller 1604, and flatly covering the surfaces of a pair of heating rubber rolls 1605 and 1606 of the film-lamination machine in an stacking way to ensure that the two ends of the adhering films are aligned; mounting the paper feeding table plate and the heating roll protective cover, and adjusting a positioner on the table plate to the same width according to the breadth of the wood fiber paper; switching on a power supply of the automatic film-lamination machine, and selecting a working mode to be a hot film-lamination mode; setting corresponding rubber roll heating temperatures and selecting a proper film-lamination speed gear according to the types and gram weights of the polymer adhering films to be covered, and starting to preheat the double rubber rolls; after the upper rubber roll and the lower rubber roll are preheated to specified temperatures, feeding the unidirectional wood fiber paper 1620 to be covered with the film from the paper feeding table plate to be between the heated double rolls 1605 and 1606, and keeping in flat and aligning with the polymer adhering films 1610 on the upper layer and the lower layer; and starting a motor to operate the rubber rolls, enabling the unidirectional wood fiber paper and the two layers of polymer adhering films to pass through the heating rolls 1605 and 1606 together, in which, a series of processes such as heating, melting, infiltrating, and press-fitting at the joints of the polymer adhering films and the heating rolls can be sequentially implemented in the penetrating process, thus finishing the film-lamination process of the unidirectional wood fiber paper. In the film-lamination process, the film-lamination speed and the gap between the heated double rolls can be properly adjusted according to conditions, so as to ensure the stability and continuity of the film-lamination process, and achieve an ideal film-lamination condition.

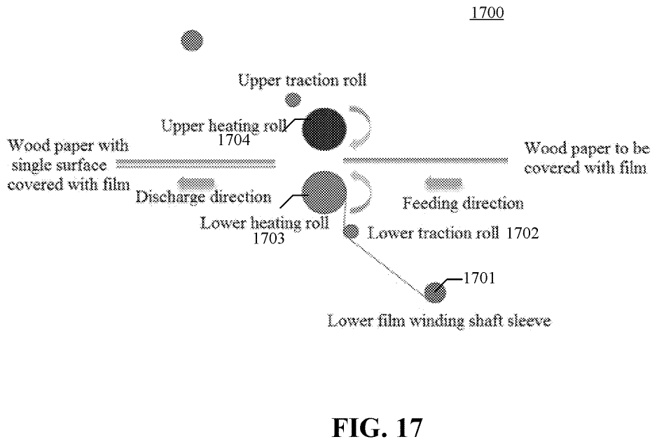

In some embodiments, according to actual requirements, the working mode can be changed from a working mode of covering films on the upper and lower surfaces to a working mode of covering the film on a single surface by heating the upper roll and laying the film on the lower roll and fitting, namely, if a double-rubber-roll preheating button is turned off, the machine will automatically switch to upper rubber roll heating mode. FIG. 17 is a preparation process of for unidirectional wood fiber paper prepreg with a single-surface film-lamination, according to some embodiments of the present disclosure. As shown in FIG. 17, the polymer adhering film reel on the lower film winding shaft sleeve 1701 is pulled out, passes through the lower traction roll 1702 and then is fed into a position between the double rollers 1703 and 1704 in transfer together with the unidirectional wood fiber paper to be covered with film, and then is subjected to a series of processes such as heating, melting, infiltration, lamination and the like sequentially, thus finishing the film-lamination process of the wood fiber paper with single surface to be covered with the film, and obtaining the unidirectional wood fiber paper prepreg.

According to the present disclosure, the polymer adhering films can be a lamellar thermoplastic polymer adhering film or a thermosetting polymer adhering film.

Further, specifically, the lamellar thermoplastic polymer adhering film includes: a continuous reticular or lamellar film material taking hot melt adhesive-grade polymers such as polyamide, polylactic acid, polyurethane, ethylene-vinyl acetate copolymer, ethylene-acrylate copolymer, and copolyester as a matrix, and a spunlace nonwoven fabric, a needle-punched nonwoven fabric, a spunbonded nonwoven fabric and a melt-blown nonwoven fabric material taking thermoplastic polymers such as polypropylene, polyamide, polylactic acid, polyester, and viscose as a matrix.

Further, specifically, the thermosetting polymer adhering film includes: a continuous lamellar film material taking thermosetting polymer precursor such as epoxy resin, unsaturated polyester, polybutadiene resin, phenolic resin, and crosslinkable polyurethane as a matrix.

According to the present disclosure, the breadth of the polymer adhering film is selected from a range of 10 mm to 5000 mm.

Further, specifically, the gram weight of the thermoplastic polymer adhering film preferably ranges from 5 g/m² to 200 g/m², more preferably ranges from 5 g/m² to 80 g/m², still more preferably ranges from 10 g/m² to 60 g/m², and most preferably ranges from 10 g/m² to 50 g/m².

Further, specifically, the gram weight of the thermosetting polymer adhering film preferably ranges from 5 g/m² to 200 g/m², still more preferably ranges from 5 g/m² to 120 g/m², and more preferably ranges from 10 g/m² to 100 g/m².

Further, specifically, the temperature of rubber roll heating preferably ranges from 70° C. to 170° C., more preferably ranges from 80° C. to 160° C., and still more preferably ranges from 110° C. to 150° C.

Further, specifically, the film-lamination rate preferably ranges from 0.6 m/min to 2.4 m/min, more preferably ranges from 0.6 m/min to 2.0 m/min, and still more preferably ranges from 0.9 m/min to 1.8 m/min.

Functional aids such as a flame retardant and an anti-moisture absorption agent can be added to the thermosetting/thermoplastic polymer system for film-lamination, and thus prepreg has the characteristics of flame retardance, moisture absorption resistance and the like.

In some embodiments, the transfer method is dip coating and/or coating, and the polymer is liquid.

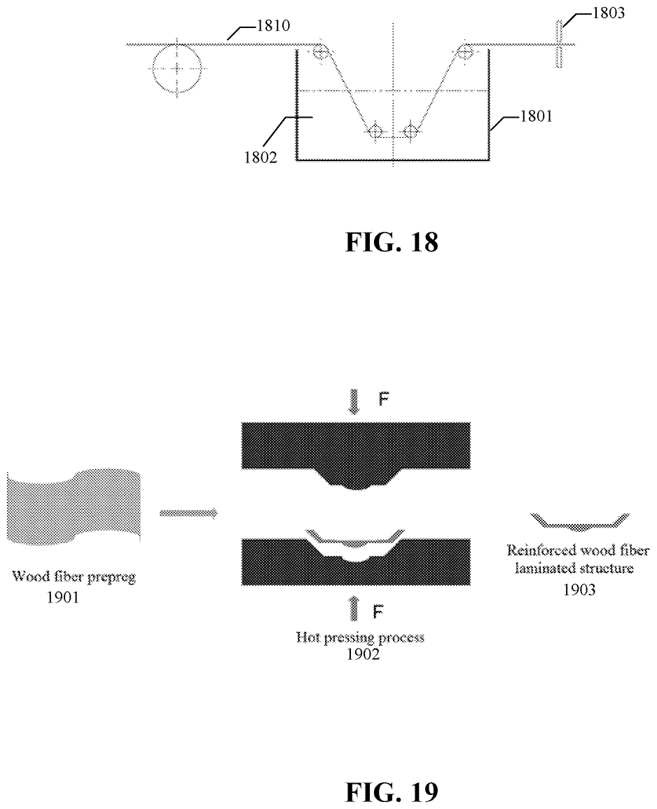

FIG. 18 is a schematic diagram of a unidirectional wood fiber paper prepreg prepared by a coating and scraping method, according to some embodiments. As shown in FIG. 18, the unidirectional wood fiber paper prepreg is prepared by the following steps: feeding (such as in a roller manner) the unidirectional wood fiber paper 1810 into a resin tank 1801 for coating/dip coating, immersing the unidirectional wood fiber paper 1810 in the liquid 1802, then continuously conveying the unidirectional wood fiber paper to a right scraper 1803, and retaining the polymer with a specific thickness on the surface of the unidirectional wood fiber paper. The polymer in the step is generally a single-component curing system and has the characteristic of low curing speed at normal temperature, and it is generally needed to be stored at normal temperature/low temperature for 3 months without losing efficacy, and curing can be finished within several hours after the temperature is raised to the use temperature. The polymer can be thermosetting polymer precursors such as epoxy resin, unsaturated polyester, polybutadiene resin, phenolic resin and crosslinkable polyurethane.

The present disclosure also provides a wood fiber paper reinforced composite, which includes a plurality of layers of unidirectional wood fiber paper; and adjacent unidirectional wood fiber paper is bonded through the polymer.

The polymers between different adjacent wood fiber paper can be the same or different in type. Further, specifically, waterproof polymer layers are preferably arranged on the surfaces of the unidirectional wood fiber paper on two surfaces of the wood fiber paper reinforced composite, and thus the waterproofness of the wood fiber paper reinforced composite can be improved.

According to the present disclosure, the tensile strength of the wood fiber paper reinforced composite preferably ranges from 130 MPa to 1000 MPa, more preferably ranges from 150 MPa to 1000 MPa.

According to the present disclosure, the flexural strength of the wood fiber paper reinforced composite preferably ranges from 130 MPa to 1000 MPa.

According to the present disclosure, the Young's modulus of the wood fiber paper reinforced composite preferably ranges from 12 GPa to 75 GPa, more preferably ranges from 12 GPa to 60 GPa.

According to the present disclosure, the ratio of a bio-based component or a natural component of the wood fiber paper reinforced composite preferably ranges from 50% to 100%.

According to the present disclosure, the volume fraction of the wood fiber paper in the wood fiber paper reinforced composite preferably ranges from 50% to 95%.

According to the present disclosure, the wood fiber paper reinforced composite has the unidirectional texture characteristics of common natural wood.

According to the wood fiber paper reinforced composite, a laminated structure is formed in the thickness direction of a cutting surface of the wood fiber paper reinforced composite; the layered distribution of the wood fiber paper reinforced composite is clearly visible in the longitudinal cross-section; and because it is needed to apply pressure in the molding process of the wood fiber paper reinforced composite, the thickness of the unidirectional wood fiber paper in the wood fiber paper reinforced composite is smaller than that of the unidirectional wood fiber paper in feedstocks, preferably in a range of 0.02 mm to 0.6 mm.

According to the present disclosure, the density of the wood fiber paper reinforced composite preferably ranges from 0.8 g/cm³ to 1.5 g/cm³.

In some embodiments, at least one surface of the wood fiber paper reinforced composite is provided with a waterproof polymer layer.

The present disclosure also provides a preparation method for the wood fiber paper reinforced composite, which includes the following steps: stacking, curing and molding the unidirectional wood fiber paper prepreg to obtain the wood fiber paper reinforced composite; or stacking, sizing and molding the unidirectional wood fiber paper to obtain the wood fiber paper reinforced composite.

FIG. 19 is a schematic diagram of a principle of preparing a wood fiber paper reinforced composite with a unidirectional wood fiber paper prepreg, according to some embodiments of the present disclosure. Referring to FIG. 19, in this example, unidirectional wood fiber paper prepregs 1901 are consolidated through hot pressing process 1902 to obtain wood fiber paper reinforced composite 1903.

In the present disclosure, the curing and molding method of the unidirectional wood fiber paper prepreg can be a conventional method for composite molding, including but not limited to an autoclave method, a vacuum bag pressing method, a counter-mold pressing method and the like; and further, the wood fiber paper prepreg can be cut into a required shape and size according to the appearance and size characteristics of the product, and then the wood fiber paper prepreg is stacked, cured and molded to obtain the wood fiber paper reinforced composite.

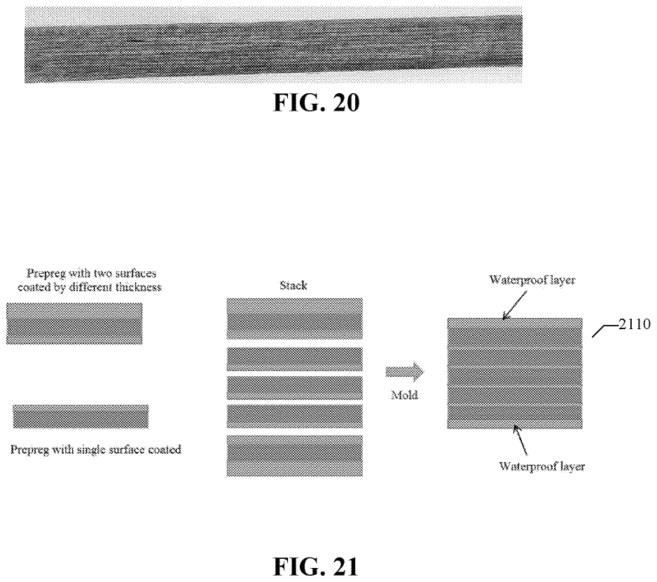

In some embodiments, the wood fiber paper reinforced composite is prepared according to the following steps: cutting the unidirectional wood fiber paper prepreg into the required shape and size, placing the prepreg in a mold according to a laying design, heating and pressurizing the prepreg, then cooling and taking out the product to obtain the required laminated structure. Specifically, the unidirectional wood fiber paper prepreg can be flexibly placed in the mold according to the laying design requirement; by the mold, the obtained wood fiber paper reinforced composite can contain complex geometric characteristics such as a plane, a curved surface, an inclined surface, a cambered surface and a cylindrical surface. FIG. 20 is a cross-sectional schematic diagram of a wood fiber paper reinforced composite, according to some embodiments of the present disclosure. The pressurization can be implemented by any one or more selected from hydraulic pressure, vacuum, compressed air ways, and the like; and the heating can be implemented by any one or more selected from electric heating, electromagnetic heating, heat radiation ways, and the like.

FIG. 21 is a schematic diagram of preparing a wood fiber paper reinforced composite with waterproof performance by a unidirectional wood fiber paper prepreg, according to some embodiments of the present disclosure. In some embodiments, the unidirectional wood fiber paper prepregs on the upper and lower surfaces and/or unidirectional wood fiber paper prepregs on upper and lower surface sub-layers in the wood fiber paper reinforced composite are preferably unidirectional wood fiber paper prepregs coated with waterproof polymers on both surfaces, and the other internal layers still adopt unidirectional wood fiber paper prepregs coated with polymers on single surface. Therefore, after molding, the outer side of the laminated structure has the waterproof polymer layer with a certain thickness 2110, and the waterproof polymer layer can effectively block water absorption, as shown in FIG. 21. The waterproof polymer is a waterproof polymer well known to those skilled in the art, and there is no special limitation, it can be epoxy resin, polyurethane, polyester, phenolic aldehyde, acrylic resin and other common thermosetting polymer systems, and can also be polyethylene, polypropylene, copolyalkenamer, polyamide, polylactic acid, acrylonitrile-butadiene-styrene copolymer, polyurethane, ethylene-vinyl acetate copolymer, ethylene-acrylate copolymer, polymethacrylate, copolyester and other thermoplastic polymer systems; and the thickness of the waterproof polymer coated in the unidirectional wood fiber paper prepregs coated with the waterproof polymers on both surfaces preferably ranges from 0.001 mm to 1 mm, more preferably ranges from 0.005 mm to 0.5 mm; and it can be simply realized by the film-lamination or dip coating method.

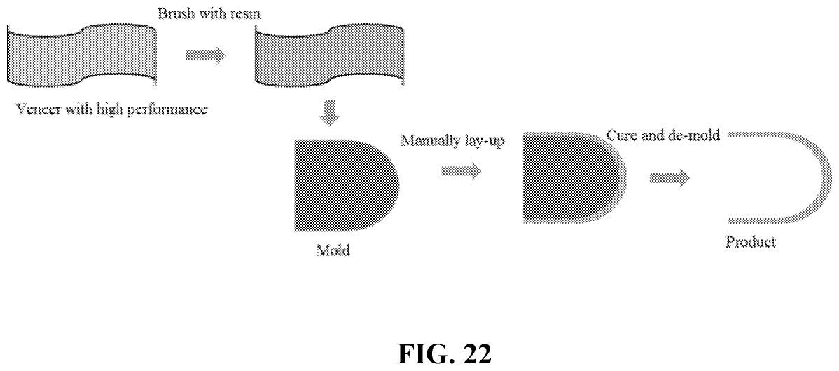

In the present disclosure, besides the unidirectional wood fiber paper prepreg, the unidirectional wood fiber paper also has good manufacturability, and it can be used for molding the product by common methods such as manual lay-up molding, resin molding transfer molding, vacuum-assisted resin molding transfer molding, compression molding, and vacuum bag pressing in the field of composites. Different from the unidirectional wood fiber paper prepreg, it is needed to coat or brush the polymer on the unidirectional wood fiber paper by a machine or by hand before molding. The polymer is as described above and is not listed herein. As shown in FIG. 22, FIG. 22 is a process schematic diagram of preparing a wood fiber paper reinforced composite by unidirectional wood fiber paper.

In the present disclosure, after the unidirectional wood fiber paper with high performance is prepared, it is immediately subjected to film-lamination/infiltration process to prepare the unidirectional wood fiber paper prepreg, and thus the later use process is simple, and it is basically completely similar to the use method for the prepreg in composite molding. A plurality of unidirectional wood fiber paper prepregs are overlapped, then the overlapped prepregs are placed into the mold, a relatively small pressure is applied, and after resin is cured, molding is implemented to obtain the product, and thus the wood fiber paper reinforced composite is prepared.

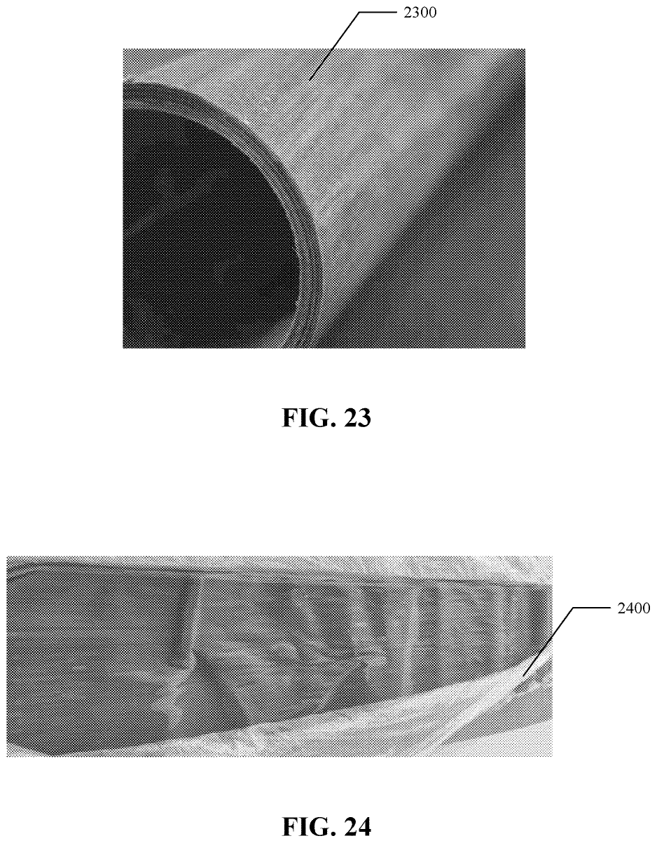

The present disclosure further provides a wood hollow tube which is formed by the unidirectional wood fiber paper, the unidirectional wood fiber paper prepreg, or the wood fiber paper reinforced composite. FIG. 23 is an object diagram of a wood hollow tube, according to some embodiments of the present disclosure. As shown in FIG. 23, a wood hollow tube 2300 is illustrated.

The forming process of the wood fiber paper reinforced composite and the wood hollow tube provided by the present disclosure is that each layer of unidirectional wood fiber paper and/or unidirectional wood fiber paper prepreg is cut into corresponding size and shape, then stacked according to the design drawing. In the stacking process, the materials are needed to form three-dimensional characteristics at the same time, for example, the materials are attached to the surface of a pre-machined mold or wound around/coated on the surface of a core rod mold, and then, de-molding is carried out after the polymer is cured, thus finishing the structure molding of the wood fiber paper reinforced composite or the wood hollow tube. In addition, because the feedstock used in the present disclosure is the unidirectional wood fiber paper and/or the unidirectional wood fiber paper prepreg, the molding capacity of the mold and the complex structure molding capacity are realized.

The present disclosure further provides a method for shrinkage of a unidirectional veneer, which includes that shrinkage treatment is carried out on the unidirectional veneer in at least one direction; and shrinkage includes transverse shrinkage and thickness shrinkage.

The unidirectional veneer is the same as the above and is not listed herein.

In some embodiments, the unidirectional veneer is subjected to chemical treatment to remove partial substances, and then subjected to shrinkage treatment in at least one direction. The chemical treatment method is the same as the above and is not listed herein.

In some embodiments, the shrinkage includes transverse shrinkage and thickness shrinkage; and the shrinkage force direction of transverse shrinkage and the shrinkage force direction of thickness shrinkage intersect.

Specifically, the unidirectional veneer includes wood fibers and/or fiber bundles; the wood fibers and/or the fiber bundles are integrally arranged or extend in a single direction on a microscopic scale. The shrinkage force of transverse shrinkage is the force in the direction parallel to the unidirectional veneer, and is in the direction intersected with the extending direction of the wood fibers and/or fiber bundles in the plane; and/or, the shrinkage force of thickness shrinkage is the force in the direction vertical to the unidirectional veneer. The force in the horizontal direction and the force in the vertical direction are each an originally applied force independent from each other, and/or, forces formed by the combination or decomposition of forces. The transverse shrinkage and the thickness shrinkage are the same as the above and are not listed herein.

In the present disclosure, unless specifically specified, the pressure refers to the pressure on the unidirectional veneer and the unidirectional wood fiber paper.

In order to further describe the present disclosure, the unidirectional wood fiber paper and the preparation method therefor, the unidirectional wood fiber paper prepreg and the preparation method therefor, and the wood fiber paper reinforced composite and the preparation method therefor are described in detail in combination with the following embodiments below.

Reagents used in the following embodiments are all commercially available.

### Example 1 (Continuous Transverse and Thickness Shrinkage Processes)

### Step 1) Chemical Treatment

A reaction solution was prepared firstly, and the total solution volume was 100 L. A reactor was a vertical reactor (externally connected to a circulating pump), and a material frame of the vertical reactor provided by the present disclosure was used for loading a unidirectional veneer for chemical treatment. Sodium hydroxide and sodium sulfite were dissolved in water, the concentration of sodium hydroxide in the reaction solution was 100 g/L, the concentration of sodium sulfite was 50 g/L, and the pH of the reaction solution was 14. Then, the reaction solution and a unidirectional basswood veneer with the thickness of 0.28 mm were put into the reactor according to the material ratio of 0.49 m²/L, the reactor was heated to 125° C. to make the whole internal system in a high-pressure state; then, after the target temperature was kept at high temperature under high pressure for 6 hours, the temperature was decreased until entering a normal temperature and normal pressure state of the internal system, then, the reactor was opened, the unidirectional veneer with partial substances removed was taken out and washed with water, and thus finishing the chemical modification process. FIG. 24 is a photo of a unidirectional veneer with partial substances removed in a wet state, according to some embodiments of the present disclosure. The mass of the finally-obtained unidirectional veneer with partial substances removed was reduced by 50%.

### Step 2) Spontaneous Transverse Shrinkage

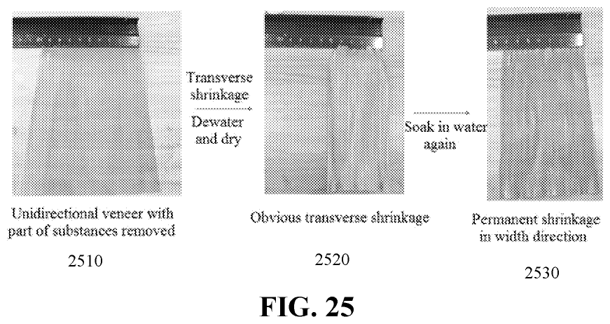

FIG. 25 is a diagram of spontaneous transverse shrinkage of a unidirectional veneer with partial substances removed, according to some embodiments of the present disclosure. Referring to FIG. 25, one unidirectional veneer with partial substances removed obtained in step 1) was prepared, and the width of the veneer was 10 cm (2510). The veneer was placed in a drying oven to be heated to 80° C., the veneer was in a dry state after 2 min to 3 min, and had obvious transverse shrinkage in the direction vertical to fiber direction, the apparent width was reduced by 50%, and the veneer obviously wrinkled (2520). The width could not be completely recovered after the veneer was soaked in water and expanded again, which indicated that a partial irreversible transverse shrinkage effect was achieved (2530).

### Step 3) Shrinkage and Levelling Treatment in Thickness Direction

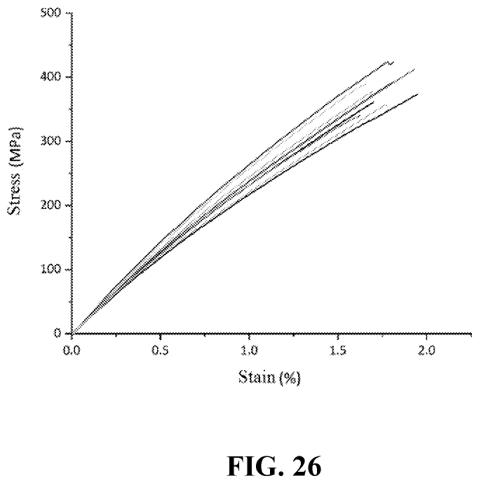

The veneer (the thickness of a feedstock was about 0.28 mm) subjected to transverse shrinkage in step 2) was shrunk in the thickness direction by a vacuum hot press in a wet state, the pressure was 6 MPa, the compression time was 0.5 min, and the temperature was 110° C. The pressure was slowly raised in the compression process, thus preventing the veneer from being crushed due to excessive impact. The compression direction was vertical to the thickness direction of veneer fibers. Because most of hemicellulose and lignin were removed by chemical modification in step 1), a pore structure of the wood was fully opened, hydroxyl groups on the surface of hydrophilic cellulose were induced to form new hydrogen bonds in the water infiltration-pressing process, and therefore adjacent wood fibers were tightly combined, and a dense veneer with the mechanical property greatly enhanced was obtained. The thickness of the veneer shrunk in the thickness direction was reduced to about 0.08 mm, and the water content was 20%. Then negative pressure and extra positive pressure (the pressure in the thickness direction of the wood fiber paper was about 0.5 MPa) were started, the flow was about 150 L/min, the temperature was still 110° C., the process was kept for 4 minutes, and then dry and flat unidirectional wood fiber paper was obtained, cracks were hardly generated basically and the probability was 5% or below, and the average thickness of the unidirectional wood fiber paper was 0.08 mm. According to a flatness testing method described in the specification, the wood fiber paper was placed between two smooth and flat glass plates, a small pressure of about 4500 Pa was applied to the surfaces of the glass, and a gap between the glass plates was measured to range from 0.15 mm to 0.2 mm (the glass plates are not completely flat, so the gap is the maximum value of the apparent thickness of the highest point and the lowest point of the wood fiber paper). The average water content was 4%, and the final width was reduced by about 30% compared with that of the wet veneer after chemical treatment. A mechanical tensile test was carried out based on a plastic tensile test standard GB/T1040.1-2006, the width of a wood fiber paper sample strip was 4 mm, the tensile rate was 2 mm/min, and a tensile curve was obtained. FIG. 26 is a curve diagram of a tensile stress strain test in a fiber direction of unidirectional wood fiber paper, according to some embodiments of the present disclosure. As shown in FIG. 26, the average breaking strength of the unidirectional wood fiber paper was 381 MPa, the average Young's modulus was 32 GPa, the tensile strength in the direction vertical to the fibers was 8.7 MPa, and the Young's modulus was 1.74 GPa.

### Comparative Example 1 (Shrinkage in Thickness Direction)

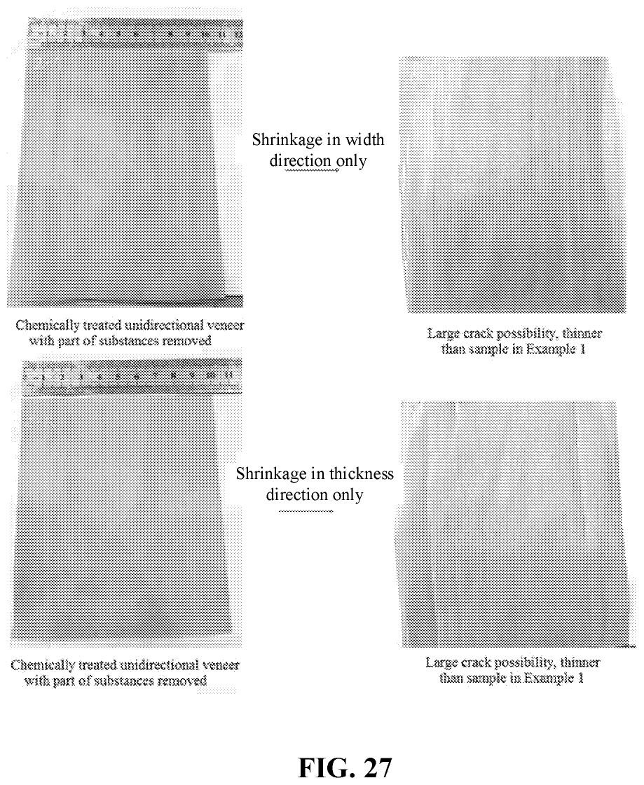

The chemical treatment was the same as that in Example 1. Transverse shrinkage procedure was not carried out, a wet veneer (with the width being 10 cm) after chemical treatment was directly subjected to shrinkage in the thickness direction through a vacuum hot press, the pressure was still 6 MPa, and the compression time was 0.5 min. The same as that in the Example 1, the negative pressure and extra positive pressure (the pressure in the thickness direction of the wood fiber paper was about 0.5 MPa) were started, the flow was about 150 L/min, the temperature was still 110° C., and the process was kept for 4 min. The press was opened, and cracks appeared on partial the wood fiber paper, the occurrence probability was about 40%, the average thickness was 0.07 mm and was smaller than that of a veneer subjected to transverse shrinkage, the width was basically not changed, as shown in FIG. 27. FIG. 27 illustrates object diagrams of a veneer shrinking in a thickness direction only after chemical treatment and shrinking in a width direction only after chemical treatment respectively, according to some embodiments of the present disclosure. A mechanical tensile test was carried out, and the obtained tensile properties of the wood fiber paper were that: the average tensile strength in the fiber direction was 348 MPa, and the average Young's modulus was 30 GPa. The tensile strength in the direction vertical to the fiber direction was 4.8 MPa, and the Young's modulus was 1.1 GPa.

For the same batch and specification of wood fiber paper, the average parameters and performance of the unidirectional wood fiber paper obtained in Example 1 and Comparative Example 1 are shown in Table 1.

TABLE 1
Average parameters and performance of unidirectional wood fiber paper

| | | | | | | Strength | Modulus |
|---|---|---|---|---|---|---|---|
| | | | | | | in | in |
| | | | | | | direction | direction |
| | | | | Strength | Modulus | vertical | vertical |
| | | Width | Thickness | in fiber | in fiber | to fiber | to fiber |
| | | shrinkage | shrinkage | direction | direction | direction | direction |
| Example 1 | Spontaneous | ~30% | ~72% | 381 MPa | 32 GPa | 8.7 MPa | 1.7 GPa |
| | transverse | | | | | | |
| | shrinkage | | | | | | |
| Comparative | No | Basically | ~75% | 348 MPa | 30 GPa | 4.8 MPa | 1.1 GPa |
| Example 1 | transverse | not | | | | | |
| | shrinkage | | | | | | |

### Example 2 (Transverse Shrinkage Mode)

The chemical treatment was the same as that of Example 1, different modes were adopted for transverse shrinkage, and the thickness compression mode was the same: the wood fiber paper was placed on a smooth metal table with a surface roughness of Ra1.6, and a cover plate was placed on the top of the smooth metal table. The cover plate was prepared by a pre-tensioned silica gel soft film, the tensioning force was in a direction vertical to the fiber direction of the wood fiber paper, and the tightness degree was adjustable. A pressure of about 0.5 MPa was applied to the cover plate to tightly attach the silica soft gel to the wood fiber paper to generate pressure, and in the process of releasing the tensioning force of the silica gel soft film, the wood fiber paper was subjected to transverse shrinkage under the action of friction force. In this example, the tension of the silica gel soft film was controlled to achieve the equivalent shrinkage pressure of 0.002 MPa, 0.2 MPa, and 1.2 MPa. The obtained thickness shrinkage ratio and the transverse shrinkage percentage of the wood fiber paper in the Example 2 were tested, then the tensile mechanical property was tested, and the results are shown in Table 2.

TABLE 2
Average parameters and performance of unidirectional wood fiber paper

| | | | | | | | Strength | | Modulus |
|---|---|---|---|---|---|---|---|---|---|
| | | | | | | | in | | in |
| | | | | | | | direction | | direction |
| | | | | | Strength | Modulus | vertical | | vertical |
| | | | Width | Thickness | in fiber | in fiber | to fiber | | to fiber |
| | | | shrinkage | shrinkage | direction | direction | direction | | direction |
| Example | Spontaneous | | ~30% | ~72% | 381 MPa | 32 GPa | 8.7 | MPa | 1.7 GPa |
| 1 | transverse | | | | | | | | |
| | shrinkage | | | | | | | | |
| Example | 0.002 | MPa | ~3% | ~75% | 375 MPa | 31 GPa | 5.0 | MPa | 1.2 GPa |
| 2 | | | | | | | | | |
| Example | 0.2 | MPa | ~32% | ~70% | 394 MPa | 33 GPa | 8.9 | MPa | 1.8 GPa |
| 2 | | | | | | | | | |
| Example | 1.2 | MPa | ~38% | ~65% | 405 MPa | 32 GPa | 10.8 | MPa | 2.1 GPa |

2

### Example 3 (Thickness Shrinkage Mode and Pressure Comparison)

The chemical treatment and transverse shrinkage mode were completely consistent with those of Example 1, and a rolling pressing method was adopted for thickness compression. The effect of adjusting the pressure in the thickness direction could be achieved by adjusting the gap between rolls, as shown in FIG. 11. In the rolling pressing process, the wood fiber paper born a resultant force composed of the pressure and the friction force in the thickness direction, and the resultant force was in the direction shown by the dotted line in the figure. The component force (pressure) in the thickness direction could make the wood fiber paper have a good shrinkage effect. In the comparative example, the last gap between the rolls was set to be 0.07 mm, and the average thickness of the compressed wood fiber paper was 0.08 mm. The tensile property of the wood fiber paper was tested, and the result is shown in Table 3.

TABLE 3
Average parameters and performance of unidirectional wood
fiber paper obtained by different thickness shrinkage modes

| | | | | | | Strength | Modulus |
|---|---|---|---|---|---|---|---|
| | | | | | | in | in |
| | | | | | | direction | direction |
| | | | | Strength | Modulus | vertical | vertical |
| | | Width | Thickness | in fiber | in fiber | to fiber | to fiber |
| | | shrinkage | shrinkage | direction | direction | direction | direction |
| Example | Rolling | ~30% | ~72% | 381 MPa | 32 GPa | 8.7 MPa | 1.7 GPa |
| 1 | pressing | | | | | | |
| Example | shrinkage | ~31% | ~71% | 390 MPa | 33 GPa | 8.5 MPa | 1.8 GPa |
| 3 | | | | | | | |

By comparing the pressure influence in thickness shrinkage, a veneer feedstock with the same specification as that of the Example 1 was selected, the chemical treatment, the transverse shrinkage mode and the thickness shrinkage mode were completely consistent with those in Example 1, and the only difference was that the pressure in thickness shrinkage was 0.02 MPa as compared with 6 MPa in the Example 1. In addition, in order to compare the thickness shrinkage effect under larger pressure, a unidirectional veneer with the same specification was selected, the chemical treatment and the transverse shrinkage were the same as those in Example 1, larger pressure of 18 MPa was adopted in thickness compression, then a vacuum press provided with an exhaust channel was used for levelling the wood fiber paper, and the levelling parameters were as follows: the pressure was 0.2 MPa, the temperature was 110° C., the flow of a vacuum air pump was about 150 L/min, and it was started for 1 min. All parameters of the unidirectional wood fiber paper obtained in the above procedures are shown in Table 4.

TABLE 4
Average parameters and performance of unidirectional wood fiber
paper obtained in different thickness shrinkage conditions

| | | | | | | | Strength | Modulus |
|---|---|---|---|---|---|---|---|---|
| | | | | | | | in | in |
| | | | | | | | direction | direction |
| | Pressure in | | | | Strength | Modulus | vertical | vertical |
| | thickness | | Width | Thickness | in fiber | in fiber | to fiber | to fiber |
| | shrinkage | | shrinkage | shrinkage | direction | direction | direction | direction |
| Example | 6 | MPa | ~30% | ~72% | 381 MPa | 32 GPa | 8.7 MPa | 1.7 GPa |
| 1 | | | | | | | | |
| Example | 0.02 | MPa | ~31% | ~28% | 155 MPa | 22 GPa | 7.7 MPa | 1.5 GPa |
| 3 | | | | | | | | |
| Example | 18 | MPa | ~30% | ~83% | 850 MPa | 75 GPa | 9.2 MPa | 2.0 GPa |

3

### Example 4 (Sequence of Compression Direction)

The chemical treatment was the same as that of Example 1, the same thickness compression mode was carried out, and the transverse shrinkage mode was the same as that of Example 2. The difference was that the thickness compression was carried out first, and then the transverse shrinkage was carried out, and the specific details are as set forth above. The wood fiber paper with excellent performance could be obtained by the mode of firstly carrying out thickness shrinkage, and the performance detection result is shown in Table 5.

TABLE 5
Average parameters and performance of unidirectional wood fiber paper

| | | | | | | Strength | Modulus |
|---|---|---|---|---|---|---|---|
| | | | | | | in | in |
| | | | | Strength | Modulus | direction | direction |
| | | | | in | in | vertical | vertical |
| | | Width | Thickness | fiber | fiber | to fiber | to fiber |
| | | shrinkage | shrinkage | direction | direction | direction | direction |
| Example | Thickness | 19% | 73% | 375 MPa | 32 GPa | 6.5 MPa | 1.6 GPa |
| 4 | shrinkage | | | | | | |
| | first, | | | | | | |
| | transverse | | | | | | |
| | shrinkage | | | | | | |
| | second | | | | | | |

The chemical treatment in Examples 5-9 is different from that in Example 1, and other processes are the same.

### Example 5

A reaction solution was prepared firstly, and the total solution volume was 20 L. A reactor is a vertical reactor, and a unidirectional veneer could be directly placed close to the wall of a bottle for reaction. Sodium hydroxide and sodium sulfite were dissolved into water, the concentration of the sodium hydroxide in the reaction solution was 100 g/L, the concentration of the sodium sulfite was 50 g/L, and the pH of the reaction solution was 14. Then, the reaction solution and a unidirectional basswood veneer with the thickness of 0.28 mm were put into the reactor according to the material ratio of 0.29 m²/L, the reactor was heated to 125° C. to make the whole internal system in a high-pressure state; then, after the target temperature was kept at high temperature under high pressure for 6 hours, the temperature was decreased until entering a normal temperature and normal pressure state of the internal system, then, the reactor was opened, the unidirectional veneer with partial substances removed was taken out and washed with water, and thus finishing the chemical modification process. The mass of the finally obtained unidirectional veneer with partial substances removed was reduced by 42.0%.

### Example 6

A reaction solution was prepared firstly, and the total solution volume was 100 L. A reactor is a vertical reactor (externally connected to a circulating pump), and a material frame of the vertical reactor provided by the present disclosure was used for loading a unidirectional veneer for chemical treatment. Sodium hydroxide and sodium sulfite were dissolved in water, the concentration of sodium hydroxide in the reaction solution was 100 g/L, the concentration of sodium sulfite was 50 g/L, and the pH of the reaction solution was 14. Then, the reaction solution and a unidirectional basswood veneer with the thickness of 0.28 mm were put into the reactor according to the material ratio of 0.12 m²/L, the reactor was heated to 125° C. to make the whole internal system in a high-pressure state; then, after the target temperature was kept at high temperature under high pressure for 4 hours, the temperature was decreased until entering a normal temperature and normal pressure state of the internal system, then, the reactor was opened, the unidirectional veneer with partial substances removed was taken out and washed with water, and thus finishing the chemical modification process. The mass of the finally obtained unidirectional veneer with partial substances removed was reduced by 46.8%.

### Example 7

A reaction solution was prepared firstly, and the total solution volume was 100 L. A reactor is a vertical reactor (externally connected to a circulating pump), and a material frame of the vertical reactor provided by the present disclosure was used for loading a unidirectional veneer for chemical treatment. Sodium hydroxide and sodium sulfite were dissolved in water, the concentration of sodium hydroxide in the reaction solution was 100 g/L, the concentration of sodium sulfite was 50 g/L, and the pH of the reaction solution was 14. Then, the reaction solution and a unidirectional basswood veneer with the thickness of 0.28 mm were put into the reactor according to the material ratio of 0.12 m²/L, the reactor was heated to 125° C. to make the whole internal system in a high-pressure state; then, after the target temperature was kept at high temperature under high pressure for 5 hours, the temperature was decreased until entering a normal temperature and normal pressure state of the internal system, then, the reactor was opened, the unidirectional veneer with partial substances removed was taken out and washed with water, and thus finishing the chemical modification process. The mass of the finally obtained unidirectional veneer with partial substances removed was reduced by 49.1%.

### Example 8

A reaction solution was prepared firstly, and the total solution volume was 3 tons. A reactor is a vertical reactor (externally connected to a circulating pump), and a material frame of the vertical reactor provided by the present disclosure was used for loading a unidirectional veneer for chemical treatment. Sodium hydroxide and sodium sulfite were dissolved in water, the concentration of sodium hydroxide in the reaction solution was 100 g/L, the concentration of sodium sulfite was 50 g/L, and the pH of the reaction solution was 14. Then, the reaction solution and a unidirectional basswood veneer with the thickness of 0.28 mm were put into the reactor according to the material ratio of 0.25 m²/L, the reactor was heated to 125° C. to make the whole internal system in a high-pressure state; then, after the target temperature was kept at high temperature under high pressure for 5 hours, the temperature was decreased until entering a normal temperature and normal pressure state of the internal system, then, the reactor was opened, the unidirectional veneer with partial substances removed was taken out and washed with water, and thus finishing the chemical modification process. The mass of the finally obtained unidirectional veneer with partial substances removed was reduced by 49.0%.

### Example 9

A reaction solution was prepared firstly, and the total solution volume was 3 tons. A reactor is a vertical reactor (externally connected to a circulating pump), and a material frame of the vertical reactor provided by the present disclosure was used for loading a unidirectional veneer for chemical treatment. Sodium hydroxide and sodium sulfite were dissolved in water, the concentration of sodium hydroxide in the reaction solution was 100 g/L, the concentration of sodium sulfite was 50 g/L, and the pH of the reaction solution was 14. Then, the reaction solution and a unidirectional basswood veneer with the thickness of 0.28 mm were put into the reactor according to the material ratio of 0.37 m²/L, the reactor was heated to 125° C. to make the whole internal system in a high-pressure state; then, after the target temperature was kept at high temperature under high pressure for 5 hours, the temperature was decreased until entering a normal temperature and normal pressure state of the internal system, then, the reactor was opened, the unidirectional veneer with partial substances removed was taken out and washed with water, and thus finishing the chemical modification process. The mass of the finally obtained unidirectional veneer with partial substances removed was reduced by 48.2%.

The unidirectional veneers with partial substances removed obtained in the Examples 5-9 were subjected to follow-up treatment according to a method in Example 1, so as to obtain the unidirectional wood fiber paper, and the tensile property of the unidirectional wood fiber paper in the fiber direction of the wood fiber paper was investigated, and the obtained result is shown in Table 6.

TABLE 6
Performance detection result of unidirectional
fiber paper obtained in Examples 5-9

| | Mass decrease | Tensile strength | Young's modulus |
|---|---|---|---|
| | after | of wood fiber | of wood fiber |
| Examples | reaction (%) | paper (MPa) | paper (GPa) |
| 5 | 42.0 | 349 | 30 |
| 6 | 46.8 | 371 | 31 |
| 7 | 49.1 | 380 | 33 |
| 8 | 49.0 | 368 | 32 |
| 9 | 48.2 | 411 | 34 |

### Example 10

The whole process was the same as that of Example 1, and a splicing process was added.

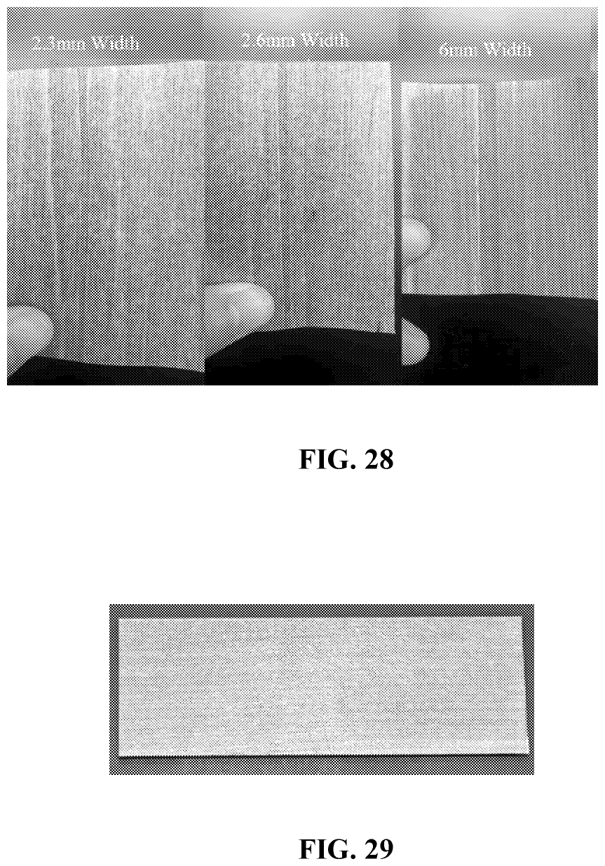

The width of the unidirectional veneer feedstock was 15 cm. The unidirectional veneers with partial substances removed were obtained by the chemical treatment method the same as that of Example 1, the edges of the unidirectional veneers with partial substances removed were overlapped in a wet state, and the stacking width ranges from 2 mm to 6 mm. Then, the shrinkage process was the same as that of Example 1 was carried out, and finally the unidirectional wood fiber paper with the width equal to the width of two pieces of unidirectional wood fiber paper, namely the stacking width was prepared. FIG. 28 illustrates photos of unidirectional wood fiber paper prepared by different stacking widths, according to some embodiments of the present disclosure.

The unidirectional wood fiber paper with the stacking width of 2.6 mm was subjected transverse tensile test, and it is found that the transverse tensile strength of the unidirectional wood fiber paper was 0.67 kN/m, which was larger than the transverse tensile strength (0.57 kN/m) of the unidirectional wood fiber paper at a non-spliced part prepared by the same method, and it was indicated that the stacking positions of the wood fiber paper were tightly combined after complete drying. Mechanical tensile test was carried out in the fiber direction, the average breaking strength of the unidirectional wood fiber paper was 347 MPa, and the average Young's modulus of the unidirectional wood fiber paper was 32 GPa. Wide unidirectional wood fiber paper could be obtained by the method.

### Example 11

The surface of the unidirectional wood fiber paper obtained in Example 1 was coated with epoxy resin (the tensile strength was 60 MPa after pure resin was cured, and the Young's modulus was 3 GPa) to obtain an epoxy-wood fiber paper prepreg. The epoxy-wood fiber paper prepreg was laid and pasted in one way and then was subjected to vacuum bag pressing for 1 hour at 80° C. until the epoxy resin was completely cured, thus obtaining a wood fiber reinforced epoxy resin matrix composite, in which, the volume percent of the wood fiber reinforced material was 90%.

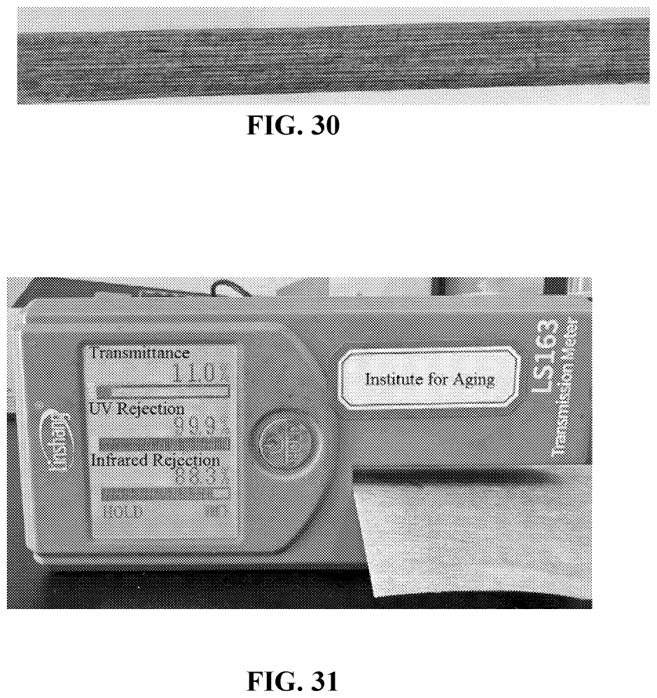

FIG. 29 is an overlook view of a wood fiber reinforced epoxy resin-based composite in Example 11, according to some embodiments of the present disclosure. FIG. 30 is a side view of a wood fiber reinforced epoxy resin-based composite in Example 11, according to some embodiments of the present disclosure.

The mechanical property of the wood fiber reinforced composite in Example 11 was investigated according to the GB/T1499-2005 Fiber-reinforced plastic composites-Determination of flexural properties, and the flexural strength of the wood fiber reinforced composite was 349 MPa, and the flexural modulus was 29 GPa. In the present disclosure, Young's modulus refers to an intrinsic axial stiffness of a material under uniaxial loading, and flexural modulus represents an effective stiffness under bending, which may differ due to shear deformation and geometric effects.

### Example 12

The unidirectional wood fiber paper obtained in Example 1 was subjected to film-lamination, and was combined with a Polyamide (PA) hot melt adhesive net film with the thickness of 0.02 mm and the areal density of 23 g/m², and thus a PA-wood fiber paper prepreg was obtained; a thermoplastic film was combined with the single surface of the PA-wood fiber paper prepreg, and the prepreg was laid and pasted in one way in the wood fiber reinforcing direction; after a structure that the wood fiber paper and the film-coated PA layer alternately stacked was formed, pressure of 0.6 MPa was applied at 130° C. for molding until PA reached a molten low-viscosity state, and thus wood fibers could be impregnated; and the wood fibers were started to be cooled to the room temperature after 10 min, PA was solidified, and thus the wood fiber reinforced polyamide composite was obtained.

The mechanical property of the wood fiber reinforced composite obtained in Example 12 was investigated according to the GB/T1499-2005 Fiber-reinforced plastic composites-Determination of flexural properties, and the flexural strength of the wood fiber reinforced composite was 363 MPa, the flexural modulus was 31 GPa, and the density was 1.30 g/cm³.

### Example 13

The chemical treatment was the same as that of Example 1. Post-treatment was also basically the same as that of Example 1, and the only difference was pressure. According to the embodiment, the veneer subjected to chemical treatment was subjected to transverse shrinkage once, the pressure of thickness shrinkage was set to be 10 MPa, and the obtained unidirectional wood fiber paper was subjected to mechanical tensile test to obtain the average breaking strength of 519 MPa, and the average Young's modulus of 37 GPa.

### Example 14

The chemical treatment was the same as that of Example 4, post-treatment was the same as that of Example 1, and the only difference was the pressure applied during transverse shrinkage. In the transverse shrinkage process, a shrinkable soft film was adopted to apply transverse shrinkage force to the wood fiber paper. Two conditions were implemented, the corresponding equivalent pressures were 0.1 MPa and 0.5 MPa respectively, the obtained unidirectional wood fiber paper was subjected to mechanical property measurement, and the result is shown in Table 7.

TABLE 7
Performance detection result of unidirectional
fiber paper obtained in Example 14

| | | | Strength in | | Modulus in |
|---|---|---|---|---|---|
| | Strength | Modulus | direction | | direction |
| Equivalent | in fiber | in fiber | vertical to | | vertical to |
| pressure | direction | direction | fiber direction | | fiber direction |
| 0.1 MPa | 365 MPa | 32 GPa | 9.1 | MPa | 1.9 GPa |
| 0.5 MPa | 386 MPa | 34 GPa | 12.3 | MPa | 2.1 GPa |

### Example 15

Part of unidirectional wood fiber paper samples (transverse shrinkage pressure being 0.1 MPa) in Example 14 were taken for light transmittance measurement, and the light transmittance was 11.0%. The test result is shown in FIG. 31.

### Example 16

The wood fiber paper obtained in Example 10 was subjected to a dip coating process to prepare an epoxy-wood fiber paper prepreg (the tensile strength was 60 MPa after pure resin is cured, and the Young's modulus was 3 GPa). The prepreg was laid and pasted in one way and then was subjected to vacuum bag pressing for 1 hour at 80° C. until epoxy resin was completely cured, and thus a wood fiber reinforced epoxy resin composite could be obtained, in which, the volume percent of the wood fiber reinforced material was 90%.

The mechanical property of the wood fiber reinforced composite obtained in Example 16 was investigated according to the GB/T1499-2005 Fiber-reinforced plastic composites-Determination of flexural properties, and the flexural strength of the wood fiber reinforced composite was 394 MPa, the bending Young's modulus was 34 GPa.

The embodiments may further be described using the following clauses:
1. Unidirectional wood fiber paper, wherein the unidirectional wood fiber paper is prepared by shrinking a unidirectional veneer with partial substances removed in at least one direction, wherein the partial the substances comprise lignin and hemicellulose; a thickness of the unidirectional wood fiber paper is smaller than or equal to 0.6 mm; and an apparent thickness of the unidirectional wood fiber paper under a pressure not larger than 0.005 MPa is not greater than 4 times of an average thickness of the unidirectional wood fiber paper.
2. The unidirectional wood fiber paper according to clause 1, wherein the unidirectional wood fiber paper comprises wood fibers or fiber bundles, the wood fibers or the fiber bundles are integrally arranged or extend in a single direction on a microscopic scale.
3. The unidirectional wood fiber paper according to clause 2, wherein a density of the unidirectional wood fiber paper ranges from 0.8 g/cm³ to 1.5 g/cm³;
and/or, an areal density of the unidirectional wood fiber paper ranges from 20 g/m² to 400 g/m²;
and/or, a tensile strength of the unidirectional wood fiber paper in a direction parallel to the wood fibers ranges from 150 MPa to 1000 MPa.
4. The unidirectional wood fiber paper according to clause 2, wherein the thickness of the unidirectional wood fiber paper ranges from 0.03 mm to 0.6 mm;
and/or, a Young's modulus of the unidirectional wood fiber paper in a direction parallel to the wood fibers ranges from 20 GPa to 80 GPa.
5. The unidirectional wood fiber paper according to clause 1, wherein the thickness of the unidirectional veneer is less than or equal to 0.8 mm;
and/or, the shrinkage comprises transverse shrinkage and thickness shrinkage according to force decomposition.
6. The unidirectional wood fiber paper according to clause 1, wherein the unidirectional veneer with partial substances shrinks in at least two directions;
the shrinkage comprises transverse shrinkage and thickness shrinkage; and
a direction of a shrinkage force of the transverse shrinkage intersects with a direction of a shrinkage force of the thickness shrinkage.
7. The unidirectional wood fiber paper according to clause 6, wherein the unidirectional veneer with partial substances removed comprises wood fibers or fiber bundles; the wood fibers or the fiber bundles are integrally arranged or extend in a single direction on a microscopic scale;
the shrinkage force of the transverse shrinkage is a force parallel to the unidirectional veneer in a horizontal direction, and in a direction intersected with an extending direction of the wood fibers and/or fiber bundles in a plane; and/or, the shrinkage force of thickness shrinkage is a force in a direction vertical to the unidirectional veneer; and
a force in a horizontal direction and a force in the vertical direction are each an originally applied force independent from each other, and/or, forces formed by force combination or force decomposition.
8. The unidirectional wood fiber paper according to clause 6, wherein the apparent thickness of the unidirectional wood fiber paper under the pressure of 0.005 MPa does not exceed 3 times of the average thickness of the unidirectional wood fiber paper;
and/or, all or partial the unidirectional wood fiber paper has smooth plastic feeling;
and/or, when the thickness of the unidirectional wood fiber paper is less than 0.15 mm, a light transmittance of all or partial the unidirectional wood fiber paper ranges from 2% to 70%.
9. The unidirectional wood fiber paper according to clause 6, wherein a weight loss of unidirectional veneer with partial substances removed ranges from 10% to 60% relative to the unidirectional veneer;
and/or, a transverse shrinkage ratio ranges from 2% to 40%; and a thickness shrinkage ratio ranges from 20% to 90%.
10. A preparation method for unidirectional wood fiber paper, comprising:
chemically modifying a unidirectional veneer to obtain a unidirectional veneer with partial substances removed; and
performing shrinkage treatment on the unidirectional veneer with partial substances removed in at least one direction to obtain the unidirectional wood fiber paper;
wherein the partial substances comprise lignin and hemicellulose; and the shrinkage comprises transverse shrinkage and thickness shrinkage according to force decomposition.
11. The preparation method according to clause 10, wherein a thickness of the unidirectional veneer ranges from 0.05 mm to 0.8 mm;
and/or, an areal density of the unidirectional veneer ranges from 20 g/m² to 450 g/m²;
and/or, the chemical modification is performed in a closed high-pressure system; a target temperature of chemical modification ranges from 100° C. to 150° C.; a target pressure of chemical modification ranges from 0.07 MPa to 1.9 MPa; the chemical modification is maintained in the target temperature/pressure for 1 hour to 12 hours;
or, the chemical modification is performed under normal pressure; the chemical modification is maintained in the target temperature/pressure for 24 hour to 72 hours; a temperature of chemical modification is the temperature at which water boils without elevated pressures;
and/or, after the chemical modification is performed, a reaction solution is cooled to obtain the unidirectional veneer with partial substances removed.
12. The preparation method according to clause 10, wherein in chemically modifying the unidirectional veneer to obtain the unidirectional veneer with partial substances removed a modification solution for chemical modification further comprises an alkaline substance, a sulfonating agent, and water;
a pH value of the modification solution ranges from 12 to 14;
a concentration of the alkaline substance in the modification solution ranges from 0.01 kg/L to 5 kg/L;
an alkaline substance is one or more selected from sodium hydroxide, potassium hydroxide, sodium bicarbonate, and potassium bicarbonate;
a concentration of the sulfonating agent in the modification solution ranges from 0.01 kg/L to 5 kg/L;
a sulfonating agent in the modification solution is one or more selected from sulfite, chlorosulfonic acid, hydroxymethylsulfonate, sulfuryl chloride, and sulfamic acid;
and/or, a material ratio of the unidirectional veneer and the modification solution for chemical modification ranges from 4.6 cm³: 1 L to 184 cm³: 1 L.
and/or, compared with the unidirectional veneer, a mass of the unidirectional veneer with partial substances removed is reduced by in a range of 10% to 60%.
13. The preparation method according to clause 10, wherein the unidirectional veneer is placed in a material frame for chemical modification;
the material frame comprises a frame body, a partition plate and a frame cover; the partition plate is arranged in the frame body; and a side wall of the frame body, a bottom of the frame body, the partition plate, and the frame cover are all provided with holes.
14. The preparation method according to clause 13, wherein the material frame is a cylindrical material frame; a plurality of the partition plates are provided; and the plurality of partition plates are arranged in concentric circles within the frame body.
15. The preparation method according to clause 13, wherein the material frame is a cuboid material frame; a plurality of the partition plates are provided; and the plurality of partition plates are arranged in parallel within the material frame.
16. The preparation method according to clause 10, wherein the shrinkage treatment comprises transverse shrinkage treatment and thickness shrinkage treatment; and a force of the transverse shrinkage treatment is intersected with a force of the thickness shrinkage treatment.
17. The preparation method according to clause 16, wherein performing the transverse shrinkage treatment comprises:
applying an external mechanical force in a transverse direction; or performing dehydration spontaneous shrinkage; and
the external mechanical force applied in the transverse direction is in a direction intersected with an extending direction of wood fibers or fiber bundles of the unidirectional veneer with partial substances removed in a plane.
18. The preparation method according to clause 17, wherein applying the external mechanical force in the transverse direction comprises:
attaching a film material that can perform transverse shrinkage to a surface of the unidirectional veneer with partial substances removed, and removing the film material after applying pressure to the unidirectional veneer with partial substances removed; and/or
performing roller rubbing treatment on the unidirectional veneer with partial substances removed; and/or
transversely applying pressure to the unidirectional veneer with partial substances removed.
19. The preparation method according to clause 17, wherein pressure for applying the external mechanical force in the transverse direction ranges from 0.001 MPa to 1.5 MPa;
and/or, a temperature of the transverse shrinkage treatment ranges from 15° C. to 150° C.;
and/or, time of the transverse shrinkage treatment ranges from 1 second to 4 minutes.
20. The preparation method according to clause 16, wherein the thickness shrinkage comprises hot-pressing treatment under a negative pressure condition;
a pressure of the hot-pressing treatment ranges from 0.1 MPa to 60 MPa;
and/or, a temperature of the hot-pressing treatment ranges from 50° C. to 150° C.;
and/or, time of the hot-pressing treatment ranges from 0.5 min to 20 min.
21. The preparation method according to clause 16, wherein the thickness shrinkage is performed on a single or stacked veneers; a number of veneers in the stacked veneers ranges from 2 to 20; and
a pressure of the thickness shrinkage treatment in the stacked condition ranges from 0.1 MPa to 60 MPa.
22. The preparation method according to clause 10, wherein a transverse shrinkage ratio ranges from 2% to 40%; and/or
a thickness shrinkage ratio ranges from 20% to 90%.
23. The preparation method according to clause 10, wherein before or after the shrinkage treatment, the method further comprises: performing splicing; and
the splicing comprises:
   marking splicing contours on the unidirectional veneer with partial substances removed or the wood fiber paper subjected to shrinkage treatment; and
   splicing the corresponding parts.
24. A preparation method for unidirectional wood fiber paper, comprising:
chemically modifying a unidirectional veneer to obtain a unidirectional veneer with partial substances removed; and
performing shrinkage treatment and levelling treatment on the unidirectional veneer with partial substances removed in at least one direction to obtain the unidirectional wood fiber paper; wherein the levelling treatment comprises:
   performing planar hot pressing in a negative pressure air pumping environment.
25. The preparation method according to clause 24, wherein exhaust channels are arranged on two contact surface or a single contact surface of the unidirectional wood fiber paper during the levelling treatment.
26. The preparation method according to clause 24, wherein a pressure in the levelling treatment ranges from 0.01 MPa to 2 MPa;
and/or, time of the levelling treatment ranges from 0.1 min to 4 min;
and/or, a temperature of the levelling treatment ranges from 40° C. to 150° C.
27. The preparation method according to clause 24, wherein the levelling treatment is one or more selected from vacuum thermoforming and negative-pressure hot-pressing treatment;
and/or, water content of the unidirectional wood fiber paper is less than or equal to 10 wt %.
28. The preparation method according to clause 24, wherein the shrinkage treatment comprises transverse shrinkage treatment and thickness shrinkage treatment;
the thickness shrinkage treatment comprises applying a mechanical pressure in a thickness direction;
wherein a pressure for applying the mechanical pressure in the thickness direction ranges from 0.01 MPa to 80 MPa;
and/or, time of the thickness shrinkage treatment ranges from 0.1 min to 3 min;
and/or, a temperature of the thickness shrinkage treatment ranges from 15° C. to 150° C.
29. A unidirectional wood fiber paper prepreg, comprising the unidirectional wood fiber paper according to any one of clauses 1 to 9 or the unidirectional wood fiber paper prepared by the preparation method according to any one of clauses 10 to 28 and a polymer layer attached to at least one surface of the unidirectional wood fiber paper.
30. The unidirectional wood fiber paper prepreg according to clause 29, wherein a mass of the polymer layer ranges from 5% to 85% of a mass of the unidirectional wood fiber paper prepreg;
and/or, a thickness ratio of the polymer layer to the unidirectional wood fiber paper ranges from (5:1) to (0.05:1);
and/or, an areal density of the unidirectional wood fiber paper prepreg ranges from 30 g/m² to 500 g/m²;
and/or, a thickness of the unidirectional wood fiber paper prepreg ranges from 0.03 mm to 0.7 mm.
31. The unidirectional wood fiber paper prepreg according to clause 29, wherein the polymer layer comprises a thermoplastic polymer and/or a thermosetting polymer; and
a gram weight of the polymer layer ranges from 5 g/m² to 200 g/m².
32. A preparation method for a unidirectional wood fiber paper prepreg, comprising the following steps:
transferring a polymer to the unidirectional wood fiber paper according to any one of clauses 1 to 9 or at least one surface of the unidirectional wood fiber paper prepared by the preparation method according to any one of clauses 10 to 28 to obtain the unidirectional wood fiber paper prepreg; and the transferring is one or more selected from film-lamination, printing, infiltration, and coating.
33. A wood fiber paper reinforced composite, comprising a plurality of layers of the unidirectional wood fiber paper according to any one of clauses 1 to 9 or the unidirectional wood fiber paper prepared by a preparation method according to any one of clauses 10 to 28; and
adjacent unidirectional wood fiber paper is bonded through a polymer.
34. The wood fiber paper reinforced composite according to clause 33, wherein a tensile strength of the wood fiber paper reinforced composite ranges from 130 MPa to 1000 MPa;
and/or, the flexural strength of the wood fiber paper reinforced composite ranges from 130 MPa to 1000 MPa;
and/or, the Young's modulus of the wood fiber paper reinforced composite ranges 12 GPa to 75 GPa.
35. The wood fiber paper reinforced composite according to clause 33, wherein a thickness of one layer of wood fiber paper in the wood fiber paper reinforced composite ranges from 0.02 mm to 0.6 mm;
and/or, a layered distribution of the wood fiber paper reinforced composite is clearly visible in a longitudinal cross-section;
and/or, a volume fraction of the wood fiber paper in the wood fiber paper reinforced composite ranges from 40% to 99%.
36. The wood fiber paper reinforced composite according to clause 33, wherein at least one surface of the wood fiber paper reinforced composite is provided with a waterproof polymer layer.
37. A preparation method for a wood fiber paper reinforced composite, comprising the following steps:
stacking, gluing and curing the unidirectional wood fiber paper according to any one of clauses 1 to 9 or the unidirectional wood fiber paper prepared by the preparation method according to any one of clauses 10 to 28 to obtain the wood fiber paper reinforced composite;
and/or, stacking, gluing and curing the unidirectional wood fiber paper prepreg according to any one of clauses 29 to 31 or the unidirectional wood fiber paper prepreg prepared by the preparation method according to clause 32 to obtain the wood fiber paper reinforced composite.
38. A method for shrinkage of a unidirectional veneer, comprising:
   performing shrinkage treatment on the unidirectional veneer in at least one direction; wherein the shrinkage comprises transverse shrinkage and thickness shrinkage according to force decomposition.
39. The method according to clause 38, further comprising:
subjecting the unidirectional veneer to chemical treatment to remove partial substances; and
performing the shrinkage treatment in at least one direction.
40. The method according to clause 38, wherein a direction of a shrinkage force of the transverse shrinkage intersects with a direction of a shrinkage force of the thickness shrinkage.
41. The method according to clause 40, wherein the unidirectional veneer comprises wood fibers and/or fiber bundles; the wood fibers and/or the fiber bundles are integrally arranged or extend in a single direction on a microscopic scale;
the shrinkage force of the transverse shrinkage is a force in a direction parallel to the unidirectional veneer, and in a direction intersected with an extending direction of the wood fibers and/or fiber bundles of the unidirectional veneer in a plane; and/or, the shrinkage force of thickness shrinkage is a force in a direction vertical to the unidirectional veneer; and
a force in a horizontal direction and a force in a vertical direction are each an originally applied force independent from each other, and/or, forces formed by force combination or force decomposition.
42. The method according to clause 40, wherein the thickness shrinkage comprises hot-pressing treatment under a negative pressure condition;
a pressure of the hot-pressing treatment ranges from 0.1 MPa to 60 MPa;
and/or, a temperature of the hot-pressing treatment ranges from 50° C. to 150° C.;
and/or, time of the hot-pressing treatment ranges from 0.5 min to 20 min.
43. A wood hollow tube, being prepared from a unidirectional wood fiber paper according to any one of clauses 1 to 9, a unidirectional wood fiber paper prepared by the preparation method according to any one of clauses 10 to 28, a unidirectional wood fiber paper prepreg according to any one of clauses 29 to 31, a unidirectional wood fiber paper prepreg prepared by the preparation method according to clause 32, a wood fiber reinforced composite according to any one of clauses 33 to 36, or a wood fiber reinforced composite prepared by the preparation method according to clause 37.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and Specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. Unidirectional wood fiber paper, wherein the unidirectional wood fiber paper is prepared by shrinking a unidirectional veneer with partial substances removed in at least one direction, wherein the partial substances comprise lignin and hemicellulose; and a thickness of the unidirectional wood fiber paper is smaller than or equal to 0.6 mm.

2. The unidirectional wood fiber paper according to claim 1, wherein the unidirectional wood fiber paper comprises wood fibers or fiber bundles, the wood fibers or the fiber bundles are integrally arranged or extend in a single direction on a microscopic scale.

3. The unidirectional wood fiber paper according to claim 2, wherein a density of the unidirectional wood fiber paper ranges from 0.8 g/cm³ to 1.5 g/cm³; or
an areal density of the unidirectional wood fiber paper ranges from 20 g/m² to 400 g/m²; or
a tensile strength of the unidirectional wood fiber paper in a direction parallel to the wood fibers ranges from 150 MPa to 1000 MPa.

4. The unidirectional wood fiber paper according to claim 2, wherein the thickness of the unidirectional wood fiber paper ranges from 0.03 mm to 0.6 mm; or
a Young's modulus of the unidirectional wood fiber paper in a direction parallel to the wood fibers ranges from 20 GPa to 80 GPa.

5. The unidirectional wood fiber paper according to claim 1, wherein the thickness of the unidirectional veneer is less than or equal to 0.8 mm; or
the shrinkage comprises transverse shrinkage and thickness shrinkage according to force decomposition.

6. The unidirectional wood fiber paper according to claim 1, wherein the unidirectional veneer with partial substances removed shrinks in at least two directions;
the shrinkage comprises transverse shrinkage and thickness shrinkage; and
a direction of a shrinkage force of the transverse shrinkage intersects with a direction of a shrinkage force of the thickness shrinkage.

7. The unidirectional wood fiber paper according to claim 6, wherein the unidirectional veneer with partial substances removed comprises wood fibers or fiber bundles; the wood fibers or the fiber bundles are integrally arranged or extend in a single direction on a microscopic scale;
the shrinkage force of the transverse shrinkage is a force parallel to the unidirectional veneer in a horizontal direction, and in a direction intersected with an extending direction of the wood fibers or fiber bundles in a plane; or the shrinkage force of thickness shrinkage is a force in a direction vertical to the unidirectional veneer; and
a force in a horizontal direction and a force in the vertical direction are each an originally applied force independent from each other, or forces formed by force combination or force decomposition.

8. The unidirectional wood fiber paper according to claim 6, wherein an apparent thickness of the unidirectional wood fiber paper under a pressure of 0.005 MPa does not exceed 3 times of an average thickness of the unidirectional wood fiber paper; or
all or partial the unidirectional wood fiber paper has smooth plastic feeling; or
when the thickness of the unidirectional wood fiber paper is less than 0.15 mm, a light transmittance of all or partial the unidirectional wood fiber paper ranges from 2% to 70%.

9. The unidirectional wood fiber paper according to claim 6, wherein a weight loss of unidirectional veneer with partial substances removed ranges from 10% to 60% relative to the unidirectional veneer; or
a transverse shrinkage ratio ranges from 2% to 40%; and a thickness shrinkage ratio ranges from 20% to 90%.

10. The unidirectional wood fiber paper according to claim 1, wherein an apparent thickness of the unidirectional wood fiber paper under a pressure not larger than 0.005 MPa is not greater than 4 times of an average thickness of the unidirectional wood fiber paper.

11. A preparation method for unidirectional wood fiber paper, comprising:
chemically modifying a unidirectional veneer to obtain a unidirectional veneer with partial substances removed; and
performing shrinkage treatment on the unidirectional veneer with partial substances removed in at least one direction to obtain the unidirectional wood fiber paper;
wherein the partial substances comprise lignin and hemicellulose; and the shrinkage comprises transverse shrinkage and thickness shrinkage according to force decomposition.

12. The preparation method according to claim 11, wherein a thickness of the unidirectional veneer ranges from 0.05 mm to 0.8 mm; or
an areal density of the unidirectional veneer ranges from 20 g/m² to 450 g/m²; or
the chemical modification is performed in a closed high-pressure system; a target temperature of chemical modification ranges from 100° C. to 150° C.; a target pressure of chemical modification ranges from 0.07 MPa to 1.9 MPa; the chemical modification is maintained in the target temperature/pressure for 1 hour to 12 hours; or
the chemical modification is performed under normal pressure; the chemical modification is maintained in the target temperature/pressure for 24 hours to 72 hours; a temperature of chemical modification is the temperature at which water boils without elevated pressures; or
after the chemical modification is performed, a reaction solution is cooled to obtain the unidirectional veneer with partial substances removed.

13. The preparation method according to claim 11, wherein in chemically modifying the unidirectional veneer to obtain the unidirectional veneer with partial substances removed a modification solution for chemical modification further comprises an alkaline substance, a sulfonating agent, and water;
wherein a pH value of the modification solution ranges from 12 to 14;
wherein a concentration of the alkaline substance in the modification solution ranges from 0.01 kg/L to 5 kg/L;
wherein the alkaline substance is one or more selected from sodium hydroxide, potassium hydroxide, sodium bicarbonate, and potassium bicarbonate;
wherein a concentration of the sulfonating agent in the modification solution ranges from 0.01 kg/L to 5 kg/L;
wherein the sulfonating agent in the modification solution is one or more selected from sulfite, chlorosulfonic acid, hydroxymethylsulfonate, sulfuryl chloride, and sulfamic acid;
wherein a material ratio of the unidirectional veneer and the modification solution for chemical modification ranges from 4.6 cm³: 1 L to 184 cm³: 1 L; or
wherein, compared with the unidirectional veneer, a mass of the unidirectional veneer with partial substances removed is reduced by 10% to 60%.

14. The preparation method according to claim 11, wherein the unidirectional veneer is placed in a material frame for chemical modification;
the material frame comprises a frame body, a partition plate, and a frame cover; the partition plate is arranged in the frame body; and a side wall of the frame body, a bottom of the frame body, the partition plate, and the frame cover are all provided with holes.

15. The preparation method according to claim 14, wherein the material frame is a cylindrical material frame; a plurality of the partition plates are provided; and the plurality of partition plates are arranged in concentric circles within the frame body.

16. The preparation method according to claim 14, wherein the material frame is a cuboid material frame; a plurality of the partition plates are provided; and the plurality of partition plates are arranged in parallel within the material frame.

17. The preparation method according to claim 11, wherein the shrinkage treatment comprises transverse shrinkage treatment and thickness shrinkage treatment; and a force of the transverse shrinkage treatment is intersected with a force of the thickness shrinkage treatment.

18. The preparation method according to claim 17, wherein performing the transverse shrinkage treatment comprises:
applying an external mechanical force in a transverse direction; or performing dehydration spontaneous shrinkage; and
the external mechanical force applied in the transverse direction is in a direction intersected with an extending direction of wood fibers or fiber bundles of the unidirectional veneer with partial substances removed in a plane.

19. The preparation method according to claim 18, wherein applying the external mechanical force in the transverse direction comprises:
attaching a film material that can perform transverse shrinkage to a surface of the unidirectional veneer with partial substances removed, and removing the film material after applying pressure to the unidirectional veneer with partial substances removed; or
performing roller rubbing treatment on the unidirectional veneer with partial substances removed; or
transversely applying pressure to the unidirectional veneer with partial substances removed.

20. The preparation method according to claim 18, wherein pressure for applying the external mechanical force in the transverse direction ranges from 0.001 MPa to 1.5 MPa; or
a temperature of the transverse shrinkage treatment ranges from 15° C. to 150° C.; or
time of the transverse shrinkage treatment ranges from 1 second to 4 minutes.

21. The preparation method according to claim 17, wherein the thickness shrinkage comprises hot-pressing treatment under a negative pressure condition;
a pressure of the hot-pressing treatment ranges from 0.1 MPa to 60 MPa; or a temperature of the hot-pressing treatment ranges from 50° C. to 150° C.; or
time of the hot-pressing treatment ranges from 0.5 min to 20 min.

22. The preparation method according to claim 17, wherein the thickness shrinkage is performed on a single or stacked veneers; a number of veneers in the stacked veneers ranges from 2 to 20; and
a pressure of the thickness shrinkage treatment for the stacked veneers ranges from 0.1 MPa to 60 MPa.

23. The preparation method according to claim 11, wherein a transverse shrinkage ratio ranges from 2% to 40%; or
a thickness shrinkage ratio ranges from 20% to 90%.

24. The preparation method according to claim 11, wherein before or after the shrinkage treatment, the method further comprises: performing splicing; and
the splicing comprises:
marking splicing contours on the unidirectional veneer with partial substances removed or the wood fiber paper subjected to shrinkage treatment; and
splicing the corresponding parts.

25. A preparation method for unidirectional wood fiber paper, comprising:
chemically modifying a unidirectional veneer to obtain a unidirectional veneer with partial substances removed; and
performing shrinkage treatment and levelling treatment on the unidirectional veneer with partial substances removed in at least one direction to obtain the unidirectional wood fiber paper; wherein the levelling treatment comprises:
performing planar hot pressing in a negative pressure air pumping environment.

26. The preparation method according to claim 25, wherein exhaust channels are arranged on two contact surfaces or a single contact surface of the unidirectional wood fiber paper during the levelling treatment.

27. The preparation method according to claim 25, wherein a pressure in the levelling treatment ranges from 0.01 MPa to 2 MPa; or
time of the levelling treatment ranges from 0.1 min to 4 min; or
a temperature of the levelling treatment ranges from 40° C. to 150° C.

28. The preparation method according to claim 25, wherein the levelling treatment is one or more selected from vacuum thermoforming or negative-pressure hot-pressing treatment; or
water content of the unidirectional wood fiber paper is less than or equal to 10 wt %.

29. The preparation method according to claim 25, wherein the shrinkage treatment comprises transverse shrinkage treatment and thickness shrinkage treatment;
the thickness shrinkage treatment comprises applying a mechanical pressure in a thickness direction;
wherein a pressure for applying the mechanical pressure in the thickness direction ranges from 0.01 MPa to 80 MPa; or
time of the thickness shrinkage treatment ranges from 0.1 min to 3 min; or
a temperature of the thickness shrinkage treatment ranges from 15° C. to 150° C.

30. A unidirectional wood fiber paper prepreg, comprising:
unidirectional wood fiber paper prepared by shrinking a unidirectional veneer with partial substances removed in at least one direction, wherein the partial substances comprise lignin and hemicellulose; and
a polymer layer attached to at least one surface of the unidirectional wood fiber paper.

31. The unidirectional wood fiber paper prepreg according to claim 30, wherein a mass of the polymer layer ranges from 5% to 85% of a mass of the unidirectional wood fiber paper prepreg; or
a thickness ratio of the polymer layer to the unidirectional wood fiber paper ranges from (5:1) to (0.05:1); or
an areal density of the unidirectional wood fiber paper prepreg ranges from 30 g/m² to 500 g/m²; or
a thickness of the unidirectional wood fiber paper prepreg ranges from 0.03 mm to 0.7 mm.

32. The unidirectional wood fiber paper prepreg according to claim 30, wherein the polymer layer comprises a thermoplastic polymer or a thermosetting polymer; and
a gram weight of the polymer layer ranges from 5 g/m² to 200 g/m².

33. A preparation method for a unidirectional wood fiber paper prepreg, comprising:
transferring a polymer to unidirectional wood fiber paper or at least one surface of the unidirectional wood fiber paper to obtain the unidirectional wood fiber paper prepreg; wherein the unidirectional wood fiber paper is prepared by shrinking a unidirectional veneer with partial substances removed in at least one direction, wherein the partial substances comprise lignin and hemicellulose; and wherein the transferring is one or more selected from film-lamination, printing, infiltration, and coating.

34. A wood fiber paper reinforced composite, comprising a plurality of layers of unidirectional wood fiber paper; wherein the unidirectional wood fiber paper is prepared by shrinking a unidirectional veneer with partial substances removed in at least one direction, wherein the partial substances comprise lignin and hemicellulose and wherein adjacent unidirectional wood fiber paper is bonded through a polymer.

35. The wood fiber paper reinforced composite according to claim 34, wherein a tensile strength of the wood fiber paper reinforced composite ranges from 130 MPa to 1000 MPa; or
the flexural strength of the wood fiber paper reinforced composite ranges from 130 MPa to 1000 MPa; or
the Young's modulus of the wood fiber paper reinforced composite ranges 12 GPa to 75 GPa.

36. The wood fiber paper reinforced composite according to claim 34, wherein a thickness of one layer of wood fiber paper in the wood fiber paper reinforced composite ranges from 0.02 mm to 0.6 mm; or
a layered distribution of the wood fiber paper reinforced composite is clearly visible in a longitudinal cross-section; or
a volume fraction of the wood fiber paper in the wood fiber paper reinforced composite ranges from 40% to 99%.

37. The wood fiber paper reinforced composite according to claim 34, wherein at least one surface of the wood fiber paper reinforced composite is provided with a waterproof polymer layer.

38. A preparation method for a wood fiber paper reinforced composite, comprising
stacking, gluing and curing unidirectional wood fiber paper to obtain the wood fiber paper reinforced composite, wherein the unidirectional wood fiber paper is prepared by shrinking a unidirectional veneer with partial substances removed in at least one direction, wherein the partial substances comprise lignin and hemicellulose; or
stacking, gluing and curing the unidirectional wood fiber paper prepreg to obtain the wood fiber paper reinforced composite, wherein the unidirectional wood fiber paper prepreg comprises the unidirectional wood fiber paper and a polymer layer attached to at least one surface of the unidirectional wood fiber paper.

39. A method for shrinkage of a unidirectional veneer, comprising:
performing shrinkage treatment on the unidirectional veneer in at least one direction; wherein the shrinkage comprises transverse shrinkage and thickness shrinkage according to force decomposition.

40. The method according to claim 39, further comprising:
subjecting the unidirectional veneer to chemical treatment to remove partial substances; and
performing the shrinkage treatment in at least one direction.

41. The method according to claim 39, wherein a direction of a shrinkage force of the transverse shrinkage intersects with a direction of a shrinkage force of the thickness shrinkage.

42. The method according to claim 41, wherein the unidirectional veneer comprises wood fibers or fiber bundles; the wood fibers or the fiber bundles are integrally arranged or extend in a single direction on a microscopic scale;
the shrinkage force of the transverse shrinkage is a force in a direction parallel to the unidirectional veneer, and in a direction intersected with an extending direction of the wood fibers or fiber bundles of the unidirectional veneer in a plane; the shrinkage force of thickness shrinkage is a force in a direction vertical to the unidirectional veneer; and
a force in a horizontal direction and a force in a vertical direction are each an originally applied force independent from each other, or forces formed by force combination or force decomposition.

43. The method according to claim 41, wherein the thickness shrinkage comprises hot-pressing treatment under a negative pressure condition;
a pressure of the hot-pressing treatment ranges from 0.1 MPa to 60 MPa; or
a temperature of the hot-pressing treatment ranges from 50° C. to 150° C.; or
time of the hot-pressing treatment ranges from 0.5 min to 20 min.

44. A wood hollow tube, wherein the wood hollow tube is prepared from one or more selected from:
a unidirectional wood fiber paper, wherein the unidirectional wood fiber paper is prepared by shrinking a unidirectional veneer with partial substances removed in at least one direction, wherein the partial substances comprise lignin and hemicellulose;
a unidirectional wood fiber paper prepreg comprising the unidirectional wood fiber paper and a polymer layer attached to at least one surface of the unidirectional wood fiber paper;
a unidirectional wood fiber paper prepreg prepared by transferring a polymer to the unidirectional wood fiber paper or at least one surface of the unidirectional wood fiber paper, and wherein the transferring is one or more selected from film-lamination, printing, infiltration, and coating;
a wood fiber reinforced composite comprising a plurality of layers of the unidirectional wood fiber paper; and
a wood fiber reinforced composite prepared by stacking, gluing and curing the unidirectional wood fiber paper or the wood fiber paper prepreg.
